(19) United States
(12) Patent Application Publication
(10) Pub. No.: US 2026/0324683 A1
(43) Pub. Date: Oct. 22, 2026

(54) ALTERNATIVE DAIRY PRODUCTS WITH MODULATED CHARACTERISTICS

(71) Applicant: Re-Milk Ltd., Ness Ziona (IL)

(72) Inventors: Carolina LAJTERER, Ness Ziona (IL); Vera SIROTINSKAYA, Ness Ziona (IL)

(21) Appl. No.: 19/486,308

(22) PCT Filed: May 29, 2024
(86) PCT No.: PCT/IL2024/050525

§ 371 Date: Nov. 20, 2025

Related U.S. Application Data
(60) Provisional application No. 63/505,066, filed on May 31, 2023.

(51) Int. Cl. A23J 3/34; A23C 11/06; A23J 3/20

(52) U.S. Cl. CPC A23J 3/347; A23C 11/065; A23J 3/20

(57) ABSTRACT

The present invention provides methods for preparing alternative dairy products comprising a high content of beta-lactoglobulin protein (BEG) and BEG hydrolysate and having one or more modulated characteristics in comparison to corresponding alternative dairy products that lack BEG hydrolysate. The invention further provides such alternative dairy products with modulated characteristic(s).

### FIELD OF THE INVENTION

The present invention relates to alternative dairy products having one or more modulated characteristics conferred by a mixture of full-length and hydrolyzed beta-lactoglobulin (BLG) proteins.

### BACKGROUND OF THE INVENTION

Proteins in general, and milk proteins in particular, are employed in the food industry for their nutritional value and functional properties, such as gelling, foaming and emulsion stabilizing. The functional characteristics of proteins can be changed by enzymatic hydrolysis, generally resulting in reduction of molecular weight, increase in number of ionizable groups, and exposure of hydrophobic groups. As different enzymes have different specificities, the choice of enzyme will dictate which peptides are generated. As a result, the hydrolysates produced by diverse enzymes may have different functionalities.

A key consideration in protein hydrolysis for modulating functional properties is the degree of hydrolysis (DH). DH is defined as the proportion (in %) of cleaved peptide bonds in a protein hydrolysate. Protein characteristics can be changed by their hydrolysis and the production of peptides, but excessive hydrolysis may have a detrimental effect, such as the release of bitter-tasting peptides. Small hydrophobic peptides and non-protein nitrogen released during enzymatic hydrolysis are the major contributors to the bitter taste. In addition to the DH, other factors may impact the functional characteristics, including hydrophobicity, molecule size, and amphipathic nature.

There is a need in the field of dairy products and specifically in the field of alternative dairy products for dairy formulations which comprise increased levels of dairy proteins while maintaining beneficial nutritional, organoleptic and rheologic attributes of legacy, animal-based dairy products.

### SUMMARY OF THE INVENTION

According to one aspect, the present invention provides a method for preparing an alternative dairy product with a modulated characteristic comprising a beta-lactoglobulin (BLG) protein, the method comprising the steps of:
(i) providing a composition comprising BLG proteins,
(ii) partially hydrolyzing the BLG proteins of the composition of step (i), thus obtaining a composition comprising a BLG protein and a BLG hydrolysate, and
(iii) formulating the composition obtained in step (ii) into an alternative dairy product, thus obtaining the alternative dairy product with the modulated characteristic,
wherein the characteristic is modulated in comparison to a corresponding characteristic in a corresponding dairy product which (a) comprises the same level of BLG proteins as in the composition of step (i), (b) is produced without the partial hydrolysis step in step (ii), or (c) is substantially devoid of a BLG hydrolysate.

In certain embodiments, the corresponding dairy product comprises the same level of BLG proteins as in the composition of step (i). In certain embodiments, the corresponding dairy product is produced without the partial hydrolysis step in step (ii). In certain embodiments, the corresponding dairy product is substantially devoid of a BLG hydrolysate. In certain embodiments, the corresponding dairy product (a) comprises the same level of BLG proteins as in the composition of step (i), (b) is produced without the partial hydrolysis step in step (ii), and (c) is substantially devoid of a BLG hydrolysate.

In some examples, the composition of step (i) comprises at least 1% w/w or from 1 to 10 wt % BLG protein.

In some examples, partially hydrolyzing the BLG proteins in step (ii) comprises contacting the BLG protein of the composition of step (i) with a protease enzyme. In some examples, the protease enzyme is selected from the group consisting of alpha-chymotrypsin, papain, trypsin, ficin, bromelain, and alcalase. In some examples, partially hydrolyzing the BLG proteins in step (ii) comprises hydrolyzing the BLG proteins to obtain a Degree of Hydrolysis (DH) of at least 0.5%. In some examples, partially hydrolyzing the BLG proteins in step (ii) comprises hydrolyzing the BLG proteins to obtain a Degree of Hydrolysis (DH) of from 1 to 9% or from 1 to 2.4%. In some examples, the weight ratio between the BLG protein and the BLG hydrolysate in the alternative dairy product obtained in step (iii) is from about 99:1, respectively, to about 1:99, respectively, or from 1:3 to about 1:7.

In some examples, the alternative dairy product obtained in step (iii) comprises from about 0.5% w/w to about 9.5% w/w or from about 1.75% w/w to about 7.5% w/w of BLG hydrolysate.

In some examples, step (iii) comprises mixing the composition obtained in step (ii) with a lipid, a mineral, a salt, a sugar, lactic acid bacteria (LAB), or any combination thereof. In some examples, step (iii) further comprises homogenization and/or pasteurization of the alternative dairy product.

In some examples, the alternative dairy product obtained in step (iii) is selected from the group consisting of an alternative milk composition, an alternative yogurt composition, an alternative soft cheese composition, an alternative ice cream composition, and an alternative hard cheese composition.

In some examples, the modulated characteristic of the alternative dairy product obtained in step (iii) is selected from the group consisting of:
(i) Degree of Hydrolysis (DH) of the BLG protein,
(ii) Level of volatile sulfuric compounds (VSCs),
(iii) Level of texture firmness,
(iv) Level of texture consistency,
(v) Level of texture cohesiveness,
(vi) Level of texture work of cohesion,
(vii) Viscosity,
(viii) Level of overall BLG protein or BLG protein hydrolyzed fragments solubility,
(ix) Level of the “L” value in the CIELAB color space,
(x) Level of the “a” value in the CIELAB color space,
(xi) Level of the “b” value in the CIELAB color space,
(xii) Gel strength,
(xiii) pH, and
(xiv) any combination of (i) to (xiii).

In some examples, the modulated characteristic of the alternative dairy product obtained in step (iii) is selected from the group consisting of:
(i) Increased Degree of Hydrolysis (DH) of the BLG protein
(ii) Decreased level of VSCs,
(iii) Decreased level of texture firmness,
(iv) Decreased level of texture consistency,
(v) Decreased level of texture cohesiveness,
(vi) Decreased level of texture work of cohesion,
(vii) Increased or decreased viscosity,
(viii) Increased overall level of BLG protein or BLG protein hydrolyzed fragments solubility,
(ix) Increased or decreased level of the “L” value in the CIELAB color space,
(x) Increased or decreased level of the “a” value in the CIELAB color space,
(xi) Increased or decreased level of the “b” value in the CIELAB color space,
(xii) Decreased gel strength,
(xiii) Decreased pH, and
(xiv) any combination of (i) to (xiii).

In some examples, the alternative dairy product obtained in step (iii) is a non-animal dairy product.

According to another aspect, the present invention provides an alternative dairy product obtained or obtainable by the methods described above or below.

According to yet another aspect, the present invention provides an alternative dairy product comprising a beta-lactoglobulin (BLG) protein and a BLG hydrolysate. In some examples, the alternative dairy product comprises from about 0.1% w/w to about 7.5% w/w, from about 0.1% w/w to about 3% w/w or from about 0.2% w/w to about 0.8% w/w BLG protein. In some examples, the alternative dairy product comprises from about 0.5% w/w to about 9.5% w/w or from about 1.75% w/w to about 7.5% w/w of BLG hydrolysate. In some examples, the alternative dairy product comprises from about 0.1% w/w to about 5% w/w BLG protein and from about 1.75% w/w to about 7.5% w/w of BLG hydrolysate. In some examples, the BLG hydrolysate has a Degree of Hydrolysis (DH) of at least 0.5%. In some examples, the BLG hydrolysate has a DH of 1% to 9% or from 1.5% to 4% or from 1.5% to 3%.

In some examples, the alternative dairy product comprises a lipid, a mineral, a salt, a sugar, lactic acid bacteria (LAB), or any combination thereof.

In some examples, the alternative dairy product is a homogenized and/or pasteurized dairy product.

In some examples, the alternative dairy product is selected from the group consisting of an alternative milk composition, an alternative yogurt composition, an alternative soft cheese composition, an alternative ice cream composition, and an alternative hard cheese composition.

In some examples, the BLG protein and the BLG hydrolysate are the only dairy protein and dairy protein hydrolysate, respectively, in the alternative dairy product. In some examples, the BLG protein and the BLG hydrolysate are the only protein and protein hydrolysate, respectively, in the alternative dairy product. In some examples, the weight ratio between the BLG protein and the BLG hydrolysate in the alternative dairy product is from about 99:1, respectively, to about 1:99, respectively, or from 1:3 to about 1:7 or from 5:1 to about 1:1.

In some examples, the alternative dairy product has at least one modulated characteristic in comparison to a corresponding characteristic in a corresponding dairy product. In some examples, the alternative dairy product has:
(i) Increased Degree of Hydrolysis (DH) of the BLG protein,
(ii) Decreased level of VSCs,
(iii) Decreased level of texture firmness,
(iv) Decreased level of texture consistency,
(v) Decreased level of texture cohesiveness,
(vi) Decreased level of texture work of cohesion,
(vii) Increased or decreased viscosity,
(viii) Increased overall level of BLG protein or BLG protein hydrolyzed fragments solubility,
(ix) Increased or decreased level of the “L” value in the CIELAB color space,
(x) Increased or decreased level of the “a” value in the CIELAB color space,
(xi) Increased or decreased level of the “b” value in the CIELAB color space,
(xii) Decreased gel strength,
(xiii) Decreased pH, or
(xiv) any combination of (i) to (xiii), in comparison to the corresponding dairy product.

In some examples, the alternative dairy product is a non-animal dairy product. In any one of the above examples, the BLG protein is a recombinant BLG protein.

### BRIEF DESCRIPTION OF DRAWINGS

FIG. 1A and FIG. 1B show the change in pH and degree of hydrolysis (DH) of BLG protein as a result of hydrolysis by ficin (FIG. 1A) or alcalase (FIG. 1B), respectively, as a function of time.

FIG. 2 shows the change in pH and DH of BLG protein as a result of hydrolysis by alcalase as a function of time.

FIG. 3 shows the effect of alpha-Chymotrypsin hydrolysis of BLG protein on several properties in certain BLG samples.

FIG. 4 shows the effect of alpha-Chymotrypsin hydrolysis of BLG protein on intensity of organic sulfur volatiles (or volatile sulfuric compounds, VSCs) in certain BLG samples.

FIG. 5 shows SDS-PAGE analysis of a controlled BLG hydrolysis by alpha-Chymotrypsin.

FIG. 6 shows SDS-PAGE analysis of a controlled BLG hydrolysis by alcalase; “b” refers to the sample before reaction, “a” after the reaction.

FIG. 7 shows the percent of intact BLG after hydrolysis. In the figure, “b” refers to the sample before reaction, “a” after the reaction. The percentage of intact BLG in FIG. 7 was calculated by measuring Coomassie intensity in ImageJ relative to “b” line in FIG. 6.

FIG. 8 shows an HPLC chromatogram of BLG samples underwent a controlled BLG hydrolysis by alcalase.

FIG. 9 shows the effect of a controlled BLG hydrolysis by alcalase on BLG gel strength of certain BLG samples.

FIG. 10 shows the effect of a controlled BLG hydrolysis by several proteases on the gel strength of certain BLG samples.

FIG. 11 shows the effect of a controlled BLG hydrolysis by alcalase on the viscosity of certain BLG samples.

FIG. 12A and FIG. 12B show the solubility of BLG and BLG hydrolysate obtained by alcalase at pH 5.3 (FIG. 12A) and pH 6 (FIG. 12B), respectively.

FIG. 13 shows the solubility of BLG and BLG hydrolysate obtained by different proteases.

FIG. 14 shows the effect of controlled BLG hydrolysis by alcalase on the buffering capacity of certain BLG samples.

FIG. 15 shows the effect of controlled BLG hydrolysis by different proteases on color of certain BLG samples (FIG. 15A—intensity; FIG. 15B—L-component intensity).

FIG. 16 shows the effect of a controlled BLG hydrolysis by alcalase on the color of certain BLG samples.

FIG. 17 shows the effect of a controlled BLG hydrolysis by alcalase on the foaming stability of certain BLG samples.

FIG. 18 shows the effect of controlled BLG hydrolysis by alcalase on the foaming capacity of certain BLG samples.

### DETAILED DESCRIPTION OF THE INVENTION

Unless otherwise defined, all technical and/or scientific terms used herein have the same meaning as commonly understood by one of ordinary skill in the art to which the invention pertains. In case of conflict, the patent specification, including definitions, will control.

The present invention provides methods of preparation of alternative dairy products comprising high content of dairy proteins, specifically whey proteins, more specifically BLG protein, and BLG protein hydrolysate, wherein the alternative dairy products have modified characteristics in comparison to corresponding products that lack BLG hydrolysate. The presence of BLG hydrolysate modulates characteristics such as a level of volatile sulfuric compounds (VSCs), level of texture firmness, level of texture consistency, level of texture cohesiveness, level of texture work of cohesion, level of texture, viscosity, color, and level of gel strength, as exemplified herein.

The methods, compositions and alternative dairy formulations provided by the present invention have several advantages over known animal-dairy products and alternative dairy products. First, without being bound to any theory or mechanism, it is contemplated that alternative dairy products comprising partly-hydrolyzed milk proteins would be more digestible than alternative dairy products comprising full, intact, non-digested milk proteins. This aspect is especially important for consumer populations having dairy digestibility problems such as infants and the elderly. A further advantage is the provision of dairy products comprising more than 1% by weight of whey proteins, which was unachievable due to the natural tendency of whey proteins to coagulate. A yet another advantage is the provision of dairy products which comprise high levels of whey proteins without having a hard gel texture, which should be avoided in non-gel dairy applications such as yogurt, milk and ice cream.

According to one aspect, the present invention provides a method for preparing an alternative dairy product comprising a beta-lactoglobulin (BLG) protein, the method comprises the steps:
a. partially hydrolyzing a non-animal BLG protein, thus obtaining a composition comprising a non-animal BLG protein and a BLG hydrolysate, and
b. formulating the composition obtained in step (a) into an alternative dairy product, thus obtaining the alternative dairy product.

According to some embodiments, the present invention provides a method for preparing an alternative dairy product comprising a beta-lactoglobulin (BLG) protein, the method comprises the steps:
(i) providing a composition comprising non-animal BLG protein,
(ii) partially hydrolyzing the BLG protein of the composition of step (i), thus obtaining a composition comprising a non-animal BLG protein and a BLG hydrolysate, and
(iii) formulating the composition obtained in step (ii) into an alternative dairy product, thus obtaining the alternative dairy product.

According to any one of the embodiments of the present invention, the resulting alternative dairy product comprises a hydrolysate of a non-animal BLG protein. According to some embodiments, such an alternative dairy product has at least one characteristic modulated in comparison to a corresponding dairy product.

The terms “corresponding dairy product” and “corresponding alternative dairy product” may be used interchangeably and refer to any consumable/edible product or foodstuff, which is similar to an alternative dairy product provided by the present invention but prepared by a method lacking the step of hydrolyzing the BLG protein as specified in the present invention and subsequently has one or more different properties. Such corresponding dairy product(s) may (i) be made by a method or process which are different in a specified way or step from methods or processes provided by the present invention, (ii) comprise a specified additional ingredient compared to an alternative dairy product provided by the present invention, (iii) does not comprise a specified ingredient compared to an alternative dairy product provided by the present invention, and/or (iv) have a specified different nutritional and/or rheologic and/or organoleptic and/or physicochemical property compared to an alternative dairy product provided by the present invention.

The term “corresponding alternative dairy product” may refer in some embodiments to an alternative dairy product comprising BLG protein in the amount that is substantially similar or substantially equal to the collective amount of BLG protein and BLG hydrolysate in the alternative dairy product and prepared by a method that is devoid of (i) hydrolyzing BLG protein, (ii) devoid of adding BLG hydrolysate during the preparation of the corresponding dairy product, or (iii) both (i) and (ii). In some embodiments, the amount of BLG protein in the corresponding dairy product is similar or equal to the collective amount of BLG protein and BLG hydrolysate in the alternative dairy product of the present invention. In some embodiments, the amount of BLG protein in the corresponding dairy product is substantially equal to the collective amount of BLG protein and BLG hydrolysate in the alternative dairy product of the present invention. According to some embodiments, the resulting dairy product has at least one characteristic modulated in comparison to a corresponding dairy product devoid of a BLG hydrolysate.

Thus, according to some embodiments, the present invention provides a method for preparing an alternative dairy product with a modulated characteristic comprising a beta-lactoglobulin (BLG) protein, the method comprises the steps:
(i) providing a composition comprising a non-animal BLG protein,
(ii) partially hydrolyzing the BLG protein of the composition of step (i), thus obtaining a composition comprising a non-animal BLG protein and a BLG hydrolysate, and
(iii) formulating the composition obtained in step (ii) into an alternative dairy product, thus obtaining the alternative dairy product with the modulated characteristic,
wherein the characteristic is modulated in comparison to a corresponding characteristic in a corresponding dairy product comprising a BLG protein and substantially devoid of a BLG hydrolysate.

In some embodiments, the corresponding dairy product comprises substantially the same amount of BLG protein as the composition of step (i). In some embodiments, the collective amount of BLG protein and BLG hydrolysate in the alternative dairy product is substantially equal to the amount of BLG protein in the corresponding dairy product which is devoid of a BLG hydrolysate.

According to some embodiments, the present invention provides a method for preparing an alternative dairy product with a modulated characteristic comprising a beta-lactoglobulin (BLG) protein, the method comprises the steps:
(i) providing a composition comprising a non-animal BLG protein,
(ii) partially hydrolyzing the BLG protein of the composition of step (i), thus obtaining a composition comprising a non-animal BLG protein and a BLG hydrolysate, and
(iii) formulating the composition obtained in step (ii) into an alternative dairy product, thus obtaining the alternative dairy product with the modulated characteristic,
wherein the characteristic is modulated in comparison to a corresponding dairy product which (a) comprises the same level of BLG proteins as in the composition of step (i), (b) is produced without the partial hydrolysis step in step (ii), or (c) comprises a BLG protein and substantially devoid of a BLG hydrolysate. In certain embodiments, the corresponding dairy product comprises the same level of BLG proteins as in the composition of step (i). In certain embodiments, the corresponding dairy product is produced without the partial hydrolysis step in step (ii). In certain embodiments, the corresponding dairy product is substantially devoid of a BLG hydrolysate. In certain embodiments, the corresponding dairy product (a) comprises the same level of BLG proteins as in the composition of step (i), (b) is produced without the partial hydrolysis step in step (ii), and (c) is substantially devoid of a BLG hydrolysate.

In certain embodiments, the corresponding dairy product comprises the same level/amount of BLG proteins as in the composition of step (i), and is substantially devoid of a BLG hydrolysate.

The terms “alternative dairy product”, “dairy substitute” and “dairy alternative”, are used herein interchangeably and refer to any consumable/edible product or foodstuff, which is not made from or derived from animals' milk. Such products may replace animal-based products in one's diet by having the nutritional and/or rheologic and/or organoleptic and/or physicochemical properties of the corresponding traditional animal-milk-based products.

The term “beta-lactoglobulin” (BLG) refers to a beta-lactoglobulin protein that is typically present in cow's milk. As used in the present invention, the term BLG further refers to isoform B of the BLG, i.e., beta-Lactoglobulin B (β-LG B), which is a small protein of 162 amino acids with a molecular mass of 18.2 kDa and optimum pH of 5.2 (UniProt D6QX31). Nevertheless, in some specific embodiments, the term BLG may refer to BLG-A isoform or to a combination of BLG-A and BLG-B. According to some embodiments, the BLG and/or the rBLG have the amino acid sequence SEQ ID NO: 1. The term “BLG protein” refers to intact protein. According to some embodiments, the BLG is a recombinant BLG. The term “BLG” encompasses known BLG variants, for example, known bovine BLG variants, and also analogs and chimera of the BLG. The term “analog”, “analog” and “sequence analog” are used herein interchangeably and refer to an analog of a peptide, polypeptide or protein having at least 70% sequence identity with the original peptide, wherein the analog retains the activity of the original peptide or protein. Thus, the terms “analog” and “active analog” may be used interchangeably. In some examples, the analog has at least 99%, 98%, 97%, 96% or 95% sequence identity with the original sequence. The term “analog” refers to a peptide, polypeptide or protein which contains substitutions, rearrangements, deletions, additions and/or chemical modifications in the amino acid sequence of the parent peptide. The substitutions of the amino acids may be conservative or non-conservative substitution. The non-conservative substitution encompasses substitution of one amino acid by any other amino acid. In one particular embodiment, the amino acid is substituted by a non-natural amino acid. The term “conservative substitution” as used herein denotes the replacement of an amino acid residue by another, without altering the overall conformation and biological activity of the peptide, including, but not limited to, replacement of an amino acid with one having similar properties (such as, for example, polarity, hydrogen bonding potential, acidic, basic, shape, hydrophobic, aromatic, and the like). Amino acids with similar properties are well known in the art. For example, according to one table known in the art, the following six groups each contain amino acids that are conservative substitutions for one another: (1) Alanine (A), Serine(S), Threonine (T); (2) Aspartic acid (D), Glutamic acid (E); (3) Asparagine (N), Glutamine (Q); (4) Arginine (R), Lysine (K); (5) Isoleucine (I), Leucine (L), Methionine (M), Valine (V); and (6) Phenylalanine (F), Tyrosine (Y), Tryptophan (W).

According to some embodiments, the BLG protein comprises an amino acid sequence selected from SEQ ID NOs: 1-10. According to some embodiments, the term BLG also encompasses analogs thereof. According to some embodiments, the BLG analog comprises an amino acid sequence selected from SEQ ID NOs: 11-20. Examples of recombinant BLG proteins are provided herein in SEQ ID NOs: 1-20.

According to some embodiments, the alternative dairy product is a non-animal alternative dairy product. The terms “non-animal” and “animal-free” refers to a product that is entirely free of animal-derived, and specifically free of milk-derived, components, such as BLG or other milk proteins. In this context, the term “milk” refers to milk from mammal animals such as cow's, goat's and sheep's milk. While all components of such products are non-animal, the present invention specifically relates to products comprising at least one recombinant component or ingredient. The term “recombinant dairy ingredient” refers to any ingredient, found in mammal dairy, that is recombinantly produced. According to one embodiment, the recombinant dairy ingredient is selected from a recombinant dairy protein, a recombinant dairy fat, and a recombinant dairy carbohydrate. According to some embodiments, the recombinant dairy ingredient is a recombinant dairy protein. According to some embodiments, the recombinant dairy protein is a recombinant whey protein. According to some embodiments, the recombinant dairy protein is β-Lactoglobulin (BLG). According to some embodiments, the recombinant dairy protein is isoform B of the BLG.

The term “substantially devoid of a BLG hydrolysate” refers to compositions that do not contain a significant amount of fragments or peptides derived from BLG protein, e.g. fragments or peptides associated with BLG hydrolysis. Fragments or peptides derived from BLG protein refer to such fragments and peptides that are obtained by hydrolysis or degradation of BLG protein. Such fragments and peptides have a molecular weight lower than the molecular weight of bovine BLG, e.g. lower than about 15 kDa. In some embodiments, the term “substantially devoid of a BLG hydrolysate” refers to compositions in which the ratio between BLG fragments/peptides and intact BLG protein is 5:100 or less. In some embodiments, the term “substantially devoid of a BLG hydrolysate” refers to compositions in which the ratio between BLG fragments/peptides and intact BLG protein is 3:100 or less. In some embodiments, the term “substantially devoid of a BLG hydrolysate” refers to compositions in which the ratio between BLG fragments/peptides and intact BLG protein is 1:100 or less. In some embodiments, the term “substantially devoid of a BLG hydrolysate” refers to compositions having a degree of hydrolysis as defined herein below lower than 0.2% or lower than 0.1% or lower than 0.05%. In some embodiments, the term “substantially devoid of a BLG hydrolysate” refers to compositions comprising less than 5% degraded BLG protein. In some embodiments, the term “substantially devoid of a BLG hydrolysate” refers to compositions that comprise less than 20%, less than 15%, less than 10% or less than 5% of peptides, polypeptides and proteins having a molecular weight below 15 kDa and having at least 95% sequence identity to the corresponding sequence of BLG protein. In some embodiments, the term “substantially devoid of a BLG hydrolysate” refers to compositions that are substantially devoid of peptides, polypeptides and proteins having a molecular weight below 15 kDa and having at least 95% sequence identity to the corresponding sequence of BLG protein.

According to some embodiments, the BLG protein constitutes at least 1% wt % of the resulting alternative dairy product. According to some embodiments, the BLG protein constitutes at least 2 wt %, at least 3 wt %, at least 4 wt %, at least 5%, at least 6 wt %, at least 8 wt % or at least 10 wt % of the alternative dairy product. According to some embodiments, the resulting alternative dairy protein comprises from 1 to 20 wt %, from 2 to 18 wt %, from 3 to 16 wt %, from 4 to 14 wt %, from 5 to 12 wt %, from 6 to 10 wt %, from 1 to 12 wt %, from 2 to 10 wt %, from 3 to 8 wt %, from 2 to 8 wt % of the BLG. According to some embodiments, the resulting alternative dairy protein comprises from 2 to 8 wt % BLG. According to some embodiments, the resulting alternative dairy protein comprises from 3 to 6 wt % BLG. According to some embodiments, the alternative dairy protein comprises from 3.5 to 5 wt % BLG. According to some embodiments, the alternative dairy product comprises at least 0.1% w/w BLG protein. According to some embodiments, the alternative dairy product comprises from 0.1% w/w to 5% w/w of BLG protein. According to some embodiments, the alternative dairy product comprises from 0.1% w/w to 3% w/w of BLG protein. According to some embodiments, the alternative dairy product comprises from 0.1% w/w to 1.5% w/w of BLG protein. According to some embodiments, the alternative dairy product comprises from 0.2% w/w to 0.8% w/w of BLG protein. According to some embodiments, the resulting dairy product comprises from about 0.5% w/w to about 5% w/w, from about 1.0% w/w to about 4.5% w/w, from about 1.5% w/w to about 4.0% w/w, from about 2.0% w/w to about 3.5% w/w, or about 2.5% w/w of BLG protein. According to some embodiments, the resulting dairy product comprises from about 0.1% w/w to about 1.5% w/w, from about 0.2% w/w to about 1.4% w/w, from about 0.3% w/w to about 1.3% w/w, from about 0.4% w/w to about 1.2% w/w, from about 0.5% w/w to about 1.1% w/w, from about 0.6% w/w to about 1.0% w/w, or from about 0.7% w/w to about 0.9% w/w of BLG protein. According to some embodiments, the alternative dairy product comprises about 0.1 w/w %, about 0.2 w/w %, about 0.3 w/w %, about 0.4 w/w %, about 0.5 w/w %, about 0.6 w/w %, about 0.7 w/w %, about 0.8 w/w %, about 0.9 w/w %, about 1.0 w/w %, about 1.1 w/w %, about 1.2 w/w %, about 1.3 w/w %, about 1.4 w/w %, about 1.5 w/w % of the BLG protein. According to some embodiments, the BLG is a recombinant BLG. According to some embodiments, the BLG is a recombinant BLG and has the amino acid sequence SEQ ID NO: 1. According to some embodiments, the BLG protein comprises an amino acid sequence selected from SEQ ID NOs: 1-20, or an analog thereof as described hereinabove.

The term “hydrolyzing” and “hydrolysis” refers to the breakage of peptide bonds of proteins and may be performed in any known method. According to some embodiments, hydrolysis is chemical hydrolysis. According to some embodiments, hydrolysis is enzymatic hydrolysis. According to some embodiments, hydrolysis is catalyzed by proteases. Therefore, according to some embodiments, the term “hydrolyzing” refers to hydrolysis by proteases. Accordingly, in some embodiments, step (ii) of the method comprises contacting the composition of step (i) with a protease enzyme and more specifically contacting the BLG of the composition of step (i) with a protease enzyme.

The term “protease” as used herein, refers to an enzyme that catalyzes a hydrolysis of a peptide (amide) bond linking amino acid residues together within a protein. The term embraces both naturally occurring, evolved, and engineered proteases. Many proteases are known in the art. Proteases can be classified by their catalytic residue. According to some embodiments, the protease is selected from serine protease (serine alcohol), threonine protease (threonine secondary alcohol), cysteine protease (cysteine thiol), aspartate protease (aspartate carboxylic acid), glutamic acid protease (glutamate carboxylic acid), metalloprotease (metal ion, e.g., zinc) and Matrix metalloproteinase. According to some embodiments, the protease is selected from caspases, collagenase, elastase, and calpain.

According to some embodiments, the protease is a food-grade protease. According to some embodiments, the protease is selected from alcalase, alpha-chymotrypsin, papain, trypsin, ficin, bromelain, pepsin, cathepsin, thrombin, renin, and furin. According to some embodiments, the protease is alcalase. According to some embodiments, the protease is alpha-chymotrypsin. According to some embodiments, the protease is ficin.

Therefore, according to some embodiments, the present invention provides a method for preparing an alternative dairy product comprising a beta-lactoglobulin (BLG) protein, the method comprises the steps: (i) providing a composition comprising non-animal BLG protein, (ii) partially enzymatically hydrolyzing the BLG protein of the composition of step (i), thus obtaining a composition comprising a non-animal BLG protein and a BLG hydrolysate, and (iii) formulating the composition obtained in step (ii) into an alternative dairy product, thus obtaining the alternative dairy product.

According to some embodiments, such an alternative dairy product has at least one characteristic modulated in comparison to a corresponding dairy product. According to some embodiments, the enzyme (protease) used in step (ii) is selected from alcalase, alpha-chymotrypsin, papain, trypsin, ficin, bromelain, pepsin, cathepsin, thrombin, renin, and furin.

According to some embodiments, the protease is a serine protease. According to other embodiments, the protease is a subtilisin-type serine protease. According to certain embodiments, the protease is alcalase. According to further embodiments, the alcalase is derived from Bacillus licheniformis. According to other embodiments, the serine protease is chymotrypsin. According to some embodiments, chymotrypsin is selected from alpha-chymotrypsin (chymotrypsin A), beta-chymotrypsin (chymotrypsin B) and chymotrypsin C. According to some embodiments, the protease is alpha-chymotrypsin.

According to some embodiments, the protease is a cysteine protease. According to some embodiments, the cysteine protease is a papain-like protease. According to some embodiments, the cysteine protease is fucin. According to certain embodiments, the fucin is derived from the latex sap of the fig tree (Ficus species), specifically from Ficus carica.

According to some embodiments, the method comprises contacting the BLG protein of the composition of step (i) with a protease enzyme at conditions optimal for the proteolytic activity of the proteases. According to some embodiments, the method comprises adjusting the pH of the composition of step (i) or step (ii) to the optimal pH for protease activity. For example, the method comprises adjusting the pH of the composition of step (i) or step (ii) to pH of from 7 to 10 when using alcalase and/or alpha-chymotrypsin. In other examples, the method comprises adjusting the pH of the composition of step (i) or step (ii) to pH of from 5 to 8 when using fucin.

According to any one of the above embodiments, the hydrolysis of the BLG in step (ii) is a partial hydrolysis resulting in BLG hydrolysate. As used herein the terms “BLG protein” refers to intact, unhydrolyzed BLG protein or recombinant BLG protein and the term “hydrolysate” as used herein refers to the product which results from hydrolysis of a substrate, i.e., of BLG protein.

According to some embodiments, partially hydrolyzing the BLG proteins in step (ii) comprises hydrolyzing the BLG proteins to obtain a Degree of Hydrolysis (DH) of at least 0.5%.

The term “degree of hydrolysis” (“DH”) as used herein defines the percentage of peptide bonds cleaved when a protein is hydrolyzed to break the protein chain into shorter chains or individual amino acids. DH is calculated according to Equation No. 1 below:

$$DH ( \% ) = \frac{B \cdot {N}_{b}}{α \cdot M \cdot {h}_{tot}} \cdot 100 \qquad Equation Number 1$$

$$α = \frac{{10}^{( pH - pK )}}{1 + {10}^{( pH - pK )}}$$

where B=base consumption, Nb=Normality of the base, α=Degree of dissociation of α-NH2 groups, M=mass of the protein, hₜₒₜ=Total number of peptide bonds and p_{K}=The average dissociation value for the α-amino acids liberated during enzymatic hydrolysis. DH can be measured by any of several known methods, including pH stat measurement, trinitrobenzenesulfonic acid (TNBS) reaction, ortho-phthaldialdehyde (OPA) reaction, trichloroacetic acid soluble nitrogen (SN-TCA), and formol titration methods. Any one of the methods may be used.

According to some embodiments, the partially hydrolyzing the BLG proteins in step (ii) comprises hydrolyzing the BLG proteins to obtain a DH of from 1% to 9%. According to some embodiments, the partially hydrolyzing the BLG proteins in step (ii) comprises hydrolyzing the BLG proteins to obtain a DH of from 1% to 8%, from 1.1 to 7%, from 1.2 to 6%, from 1.3 to 5%, from 1.5 to 4%, from 1.6 to 3%, from 1.8 to 2.8%, or from 2 to 2.5%. According to some embodiments, the partially hydrolyzing the BLG proteins in step (ii) comprises hydrolyzing the BLG proteins to obtain a DH of from 0.7% to 3%, from 0.8% to 2.9%, from 1% to 3%, from 1.1 to 2.8%, from 1.2 to 2.5%, from 1.3 to 2.4%, from 1.4 to 2.3%, from 1.5 to 2.2%, from 1.8 to 2.4%, or from 1.8 to 2.3%. According to some embodiments, the partially hydrolyzing the BLG proteins in step (ii) comprises hydrolyzing the BLG proteins to obtain a DH of from 0.7 to 2.4%. According to some embodiments, the partially hydrolyzing the BLG proteins in step (ii) comprises hydrolyzing the BLG proteins to obtain a DH of about 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3% or 2.4%. According to some embodiments, the partially hydrolyzing the BLG proteins in step (ii) comprises hydrolyzing the BLG proteins to obtain a DH of below 2.5% or below 2.4%. According to some embodiments, the partially hydrolyzing the BLG proteins in step (ii) comprises hydrolyzing the BLG proteins to obtain a DH of below 2.5% or below 2.4% and above 0.5%.

According to some embodiments, the resulting alternative dairy product comprises a hydrolysate of BLG with a DH of from 1 to 8%, or from 1.1 to 7%, from 1.2 to 6%, from 1.3 to 5%, from 1.5 to 4%, from 1.6 to 3%, from 1.8 to 2.8%, or from 2 to 2.5%.

According to some embodiments, the partially hydrolyzing the BLG proteins in step (ii) is terminated when a predetermined or desired BLG protein DH is obtained. According to other embodiments, the partially hydrolyzing the BLG proteins in step (ii) is terminated when a predetermined and desired BLG protein DH is obtained. The termination of hydrolysis may be performed by any known method. A non-limiting example of terminating the hydrolysis is heating the composition of step (ii) after performing the hydrolysis to a temperature sufficient to deactivate the protease. According to some embodiments, terminating the hydrolysis comprises heating the composition of step (ii) after performing the hydrolysis to a temperature of from 80 to 99° C. or from 85 to 95° C. or from 90 to 98° C. or to a temperature selected from 90° C., 92° C., 95° C. and 98° C. According to some embodiments, terminating the hydrolysis comprises heating the composition of step (ii) after performing the hydrolysis to a temperature as described above for from 1 to 10 minutes, from 2 to 8 minutes, from 3 to 6 minutes or for 5 minutes. According to some embodiments, terminating the hydrolysis comprises heating the composition of step (ii) after performing the hydrolysis to a temperature of from 80 to 99° C. or from 85 to 95° C. or from 90 to 98° C. or to a temperature selected from 90° C., 92° C., 95° C. and 98° C. for from 2 to 8 minutes, from 3 to 6 minutes or for 5 minutes.

According to some embodiments, terminating the hydrolysis comprises changing the pH of the composition of step (ii) after performing the hydrolysis to a pH that deactivates the protease. According to some embodiments, terminating the hydrolysis comprises adding a protease inhibitor to the composition of step (ii) after performing the hydrolysis to deactivate the protease. According to some embodiments, terminating the hydrolysis comprises removing the protease from the composition, e.g. by filtration or centrifugation of proteases bound to a solid support such as beads.

According to some embodiments, the weight ratio between the BLG protein and the BLG hydrolysate in the composition resulting from the partial hydrolysis in step (ii) and subsequently in the alternative dairy product obtained in step (iii) is from about 99:1, respectively, to about 1:99, respectively. According to some embodiments, the weight ratio between the BLG protein and the BLG hydrolysate is from 95:5 to 5:95, from 90:1 to 1:90, from 80:1 to 1:80, from 70:1 to 1:70, from 60:1 to 1:60, from 50:1 to 1:50, from 40:1 to 1:40, from 30:1 to 1:30, from 20:1 to 1:20, or from 15:1 to 1:15. According to some embodiments, the weight ratio between the BLG protein and the BLG hydrolysate is from about 10:1 to about 1:10, from about 9:1 to about 1:9, from about 8:1 to about 1:8, from about 7:1 to about 1:7, from about 6:1 to about 1:6, from about 5:1 to about 1:5, from about 4:1 to about 1:4, from about 3:1 to about 1:3, from about 2:1 to about 1:2, or about 1:1. According to some embodiments, the weight ratio between the BLG protein and the BLG hydrolysate is from about 1:3 to about 1:7. According to some embodiments, the weight ratio between the BLG protein and the BLG hydrolysate is from about 1:4 to about 1:6. According to some embodiments, the weight ratio between the BLG protein and the BLG hydrolysate is from about 3:1 to about 7:1. According to some embodiments, the weight ratio between the BLG protein and the BLG hydrolysate is from about 4:1 to about 6:1.

According to some embodiments, the alternative dairy product obtained in step (iii) comprises from 0.5% w/w to 9.5% w/w of BLG hydrolysate. According to some embodiments, the alternative dairy product obtained in step (iii) comprises from 1.0% w/w to 9.0% w/w, from 1.5% w/w to 8.5% w/w, from 2.0% w/w to 8.0% w/w, from 2.5% w/w to 7.5% w/w, from 3.0% w/w to 7.0% w/w, from 3.5% w/w to 6.5% w/w, from 4.0% w/w to 6.0% w/w, from 4.5% w/w to 5.5% w/w, or about 5.0% w/w BLG hydrolysate.

According to some embodiments, the alternative dairy product obtained in step (iii) comprises from 1.75% w/w to 7.5% w/w, from 2.25% w/w to 7.0% w/w, from 2.75% w/w to 6.5% w/w, from 3.25% w/w to 6.0% w/w, from 3.75% w/w to 5.5% w/w, from 4.25% w/w to 5.0% w/w, from 4.75% w/w to 4.5% w/w of BLG hydrolysate.

According to some embodiments, the alternative dairy product obtained in step (iii) comprises from 1% w/w to 5% w/w, from 1.2% w/w to 4.8% w/w, from 1.4% w/w to 4.6% w/w, from 1.6% w/w to 4.4% w/w, from 1.8% w/w to 4.2% w/w, from 2.0% w/w to 4.0% w/w, from 2.2% w/w to 3.8% w/w, from 2.4% w/w to 3.6% w/w, from 2.6% w/w to 3.4% w/w, from 2.8% w/w to 3.2% w/w, or about 3.0% w/w of BLG hydrolysate. According to some embodiments, the alternative dairy product obtained in step (iii) comprises from about 2.5 wt % to about 3.5 wt % of BLG hydrolysate.

According to some embodiments, the alternative dairy product obtained in step (iii) comprises from 1% w/w to 5% w/w, from 1.2% w/w to 4.8% w/w, from 1.4% w/w to 4.6% w/w, from 1.6% w/w to 4.4% w/w, from 1.8% w/w to 4.2% w/w, from 2.0% w/w to 4.0% w/w, from 2.2% w/w to 3.8% w/w, from 2.4% w/w to 3.6% w/w, from 2.6% w/w to 3.4% w/w, from 2.8% w/w to 3.2% w/w, or about 3.0% w/w of BLG hydrolysate and from 1% w/w to 5% w/w, from 1.2% w/w to 4.8% w/w, from 1.4% w/w to 4.6% w/w, from 1.6% w/w to 4.4% w/w, from 1.8% w/w to 4.2% w/w, from 2.0% w/w to 4.0% w/w, from 2.2% w/w to 3.8% w/w, from 2.4% w/w to 3.6% w/w, from 2.6% w/w to 3.4% w/w, from 2.8% w/w to 3.2% w/w, or about 3.0% w/w of intact BLG protein. According to some embodiments, the alternative dairy product obtained in step (iii) comprises from 1% w/w to 5% w/w of BLG hydrolysate and from 1% w/w to 5% w/w of intact BLG protein. According to some embodiments, the weight ratio between the BLG protein and the BLG hydrolysate is from about 10:1 to about 1:10, from about 9:1 to about 1:9, from about 8:1 to about 1:8, from about 7:1 to about 1:7, from about 6:1 to about 1:6, from about 5:1 to about 1:5, from about 4:1 to about 1:4, from about 3:1 to about 1:3, from about 2:1 to about 1:2, or about 1:1. According to some embodiments, the alternative dairy product obtained in step (iii) comprises from 1% w/w to 5% w/w of BLG hydrolysate, from 1% w/w to 5% w/w of intact BLG protein and the weight ratio between the BLG protein and the BLG hydrolysate is from about 5:1 to about 1:5, from about 4:1 to about 1:4, from about 3:1 to about 1:3, from about 2:1 to about 1:2, or about 1:1.

According to any one of the above embodiments, step (iii) comprises formulating the composition obtained in step (ii) into an alternative dairy product. According to some embodiments, step (iii) comprises mixing the composition obtained in step (ii) with a lipid, a mineral, a salt, a sugar, lactic acid bacteria (LAB), or any combination thereof. According to some embodiments, the composition of step (ii) is added to a composition comprising a lipid, a mineral, a salt, a sugar, lactic acid bacteria (LAB), or any combination thereof. According to some embodiments, the lipid, a mineral, a salt, a sugar, lactic acid bacteria (LAB), or any combination thereof is added to the composition of step (ii). According to some embodiments, step (iii) comprises mixing the composition obtained in step (ii) with a lipid, a mineral, a salt, a sugar, and LAB. As used herein the term mixing has the meaning of adding one ingredient to another and mixing to obtain a homogenous composition.

According to some embodiments, the lipid is a non-animal lipid. The term “non-animal lipid” refers to any lipid, fat and oil that does not originate from an animal and/or milk. According to some embodiment, the lipid is plant-derived lipid. According to some embodiments, the lipids comprise an oil. According to some embodiment, the oil is selected from shea oil, sunflower oil, coconut oil, rapeseed oil, nut oil, palm oil, kernel oil, olive oil, soya oil, cotton oil, and cocoa butter (Theobroma oil). According to some embodiments, the method comprises adding from 1 to 40 wt % of the non-animal fat. According to some embodiments, the method comprises adding from 1 to 10 wt % of the non-animal fat. According to some embodiments, the method comprises adding from 10 to 40 wt %, from 15 to 35 wt % or from 20 to 30 wt % of the non-animal fat such as plant oil.

According to some embodiments, formulating the alternative dairy product comprises adding a sweetener. The term “sweetener” refers to any natural and artificial substances that provides a sweet taste in foods and beverages. According to some embodiments, the term sweetener excludes lactose. The term “sweetener” also comprises sugars and carbohydrates. The term “sweetener” as used herein refers to an organic compound that is generally sweet in taste. For example, sweeteners are generally used to impart a sweet taste in edible products. A sweetener can include artificial sweeteners and natural sweeteners such as plant-derived sweeteners. A sweetener can be generally safe for consumption. A sweetener suitable for use according to the present disclosure can have a sweetness intensity that is lower, similar to or greater than that of sucrose depending on the desired sweetness in the final product. In some instances, the sweeteners have a sweetness intensity that is greater than that of sucrose. Those sweeteners can be high intensity sweeteners. Sweeteners are often classified as either nutritive (caloric) or non-nutritive (non-caloric), natural or synthetic. Examples of sweeteners include but are not limited to sucrose, dextrose, lactose, glucose, advantame, sorbitol, mannitol, liquid glucose, honey molasses, saccharin, sucralose, rebaudioside A stevia, rebaudioside M stevia, stevioside, mogroside IV, mogroside V, alitame, saccharin, neohesperidin dihydrochalcone, cyclamate, neotame, N-[3_(3-hydroxy-4-methoxybenzyl yl) propyl]-L-a-aspartyl]-L-phenylalanine 1-methyl ester, N-[3-(3-hydroxy-4-methoxyphenyl)-3-methylbutan yl]-L-a-aspartyl]-L-phenylalanine 1-methyl ester, N-[3-(3-methoxy-4-hydroxyphenyl) propyl]-L-a-aspartyl]-L-phenylalanine 1-methyl ester, curculin, cyclamate, aspartame, acesulfame potassium and others or mixtures thereof. In some embodiments, the sweetener is a sugar. According to some embodiments, formulating the alternative dairy product comprises adding a sugar. According to some embodiments, sugar may be added in one step or in a plurality of steps. According to some embodiments, sugar is added in step (i). According to some embodiments, sugar is added after completion of the fermentation. The term “sugar” refers to any edible sugar, carbohydrate, or sugar substitute. According to some embodiments, the sugar is a non-animal sugar. According to some embodiment, the sugar is plant-derived sugar. According to some embodiments, the sugar is selected from a monosaccharide, disaccharide, and polysaccharide. According to some embodiments, the sugar is selected from glucose, fructose, mannose, xylose, arabinose, sucrose, dextrose, maltose, and galactose. According to some embodiments, the sugar is dextrose. According to some embodiments, the method comprises adding from 1 to 20 wt % of sugar. According to some embodiments, the method comprises adding from 1 to 5 wt % of sugar. According to some embodiments, the method comprises adding from 1 to 15 wt % of sugar. According to some embodiments, the method comprises adding from 1 to 5%, from 2 to 4 or about 3.2% of dextrose.

According to any one of the above embodiments, the LAB is a non-pathogenic LAB capable of acidifying milk, generating flavor, texture, and any combination of the above. According to any one of the above embodiments, the LAB is a non-pathogenic LAB capable of acidifying an alternative dairy product, generating flavor, generating texture, and any combinations of the above. The LAB can be a mixed-strain or defined-strain cultures. In some examples, the bacteria culture is mesophilic. In some other examples, the bacteria culture is thermophilic. According to some embodiments, the LAB is selected from Lactobacillus Bulgaricus, Streptococcus Thermophilus, Streptococcus Group N1, Leuconostoc, Lactobacillus Acidophilus, Lactobacillus Casei, Lactobacillus Paracasei, Bifidobacterium Lactis, Lactococcus lactis subsp. Lactis, Leuconostoc Mesenteroides subsp, Lactobacillus Acidophilus, and any combinations thereof. According to some embodiments, the LAB is Lactobacillus Bulgaricus. According to some embodiments, the LAB is Streptococcus Thermophilus. According to some embodiments, the LAB is a combination of Lactobacillus Bulgaricus and Streptococcus Thermophilus.

According to some embodiments, the step of formulating an alternative dairy product comprises adding yeast extract. According to some embodiments, the method comprises adding from 0.005 to 0.5 wt % of yeast extract. According to some embodiments, the method comprises adding from 0.01 to 0.45 wt %, from 0.015 to 0.4 wt %, from 0.02 to 0.35 wt %, from 0.025 to 0.3 wt %, from 0.01 to 0.08 wt %, from 0.01 to 0.07 wt %, from 0.01 to 0.06 wt %, from 0.015 to 0.05 wt %, from 0.02 to 0.04 wt %, or about 0.03 wt % of yeast extract.

According to any one of the above embodiments, the method comprises adding mineral. According to some embodiments, the mineral is a coagulation mineral salt. According to some embodiments, the coagulation mineral salt is added before adding the LAB. The terms “coagulation salt”, “coagulation mineral” and “coagulation mineral salt” may be used herein interchangeably and refer to a mineral, e.g., in the form of soluble salt, or ions thereof that initiate protein coagulation, as known in the art. It is known that soluble salt upon dissolution disintegrates into ions forming it. Thus, according to some embodiments, the term salt refers also to a dissolved coagulation salt. Upon dissolution, coagulation mineral salt provides cations that initiate coagulation. According to some embodiments, the coagulation mineral comprises one or more salts of a mineral selected from calcium, magnesium, phosphorus, potassium, selenium, and zinc. In some examples, the coagulation mineral is calcium or magnesium. In some examples, the coagulation mineral salt is a calcium salt or a magnesium salt. In some examples, the coagulation mineral salt is selected from calcium chloride, magnesium chloride, and calcium lactate. According to some embodiments, the coagulation mineral salt is calcium chloride. According to some embodiments, the method comprises adding from about 0.0015 to about 0.35 wt % of the coagulation mineral salt. According to some embodiments, the method comprises adding from about 0.005 to about 0.25 wt %, from about 0.01 to about 0.20 wt % or from about 0.05 to about 0.2 wt % of the coagulation mineral salt, such as calcium chloride. According to some embodiments, the salt is a flavoring salt. According to some embodiments, the salt is sodium chloride.

According to some embodiments, the method comprises adding a stabilizer. According to some embodiments, the stabilizer is added in step (i). The term “stabilizer” as used herein refers to an additive to food which helps to preserve its structure. Non-limiting examples of stabilizers are functional enzymatically treated potato starch such as Etenia 457, starch, Locust bean gum, pectin, Carrageenan, and any combination thereof. According to some embodiments, the method further comprises adding from about 0.01 to about 3 wt % of the stabilizer.

According to any one of the above embodiments, the method of formulating the alternative dairy product further comprises adding a chelating agent at step (i). The terms “chelating agent”, “chelating salt”, “chelator”, “coagulation mineral chelator” and “chelating mineral” are used herein interchangeably and refer to agents capable of chelating cations, such as divalent ions. In some embodiments, the chelating agent chelates divalent ions. In some embodiments, the chelating agent is added to chelate divalent cation(s) to prevent early or spontaneous coagulation. In some examples, the chelating agent is a sodium salt. In some examples, the chelating agent is selected from sodium citrate, trisodium citrate, sodium phosphate, and sodium orthophosphate. In some examples, the salt is in its soluble form. In some other examples, the salt is in dry form. According to some embodiments, the method further comprises adding from about 0.01 to about 1 wt % of the stabilizer.

According to any one of the above embodiments, the method of formulating the alternative dairy product comprises LAB fermentation thereby obtaining a fermented dairy product. The term “acidification” and “fermentation” refers to the process of reducing the pH of the composition carried out using LAB. According to some embodiments, the alternative dairy product is allowed to ferment for at least 4.5, at least 6, at least 8, at least 12 hours or at least 16 hours. According to some embodiments, the alternative dairy product is fermented for from about 4.5 to about 48 hours. According to some embodiments, the alternative dairy product is fermented for from about 4.5 to about 24 hours. According to some embodiments, the alternative dairy product is fermented for from about 6 to about 16 hours, from about 6 to about 12 hours, from about 7 to about 14 hours, or from about 8 to about 12 hours. According to some embodiments, the alternative dairy product is fermented at a temperature of from 30 to 45° C., from 34 to 42° C., from 35 to 40° C. or at about 37° C. According to some embodiments, the alternative dairy product is allowed to ferment for from 4.5 to 48 hours at a temperature of from 30 to 45° C. According to some embodiments, the alternative dairy product is allowed to ferment for from 6 to 16 hours at a temperature of from 35 to 40° C. According to some embodiments, the alternative dairy product is allowed to ferment for from 6 to 12 hours at a temperature of from 35 to 40° C. According to some embodiments, the method comprises fermentation for about 6, about 7, about 8, about 9, about 10, about 12, about 14 or about 16 hours at a temperature of from 35 to 40° C. According to some embodiments, the alternative dairy product is allowed to ferment until the pH reaches the desired pH, e.g. from 3.9 to 4.7.

According to some embodiments, the fermentation may be carried out in the final container. According to some embodiments, the filling of the alternative dairy product into a final container is performed in aseptic conditions.

According to any one of the above embodiments, the method further comprises adjusting the pH of a composition of step (iii) to the range of from 6.4 to 7.2 at any step before adding the LAB. According to some embodiments, the method comprises adjusting the pH of the composition to from 6.6 to about 7. According to some embodiments, the method comprises adjusting the pH of the composition to about 6.8.

According to some embodiments, step (iii) further comprises homogenization of the alternative dairy product. According to some embodiments, step (iii) further comprises pasteurization of the alternative dairy product. According to some embodiments, step (iii) further comprises homogenization and pasteurization of the alternative dairy product.

The terms “homogenized” and “homogenization” refer to the process or to the product that passed the process of homogenization. Homogenization may be performed by any known method and/or device. According to some embodiments, the homogenization is performed in 1, 2, 3 or 4 stages. According to some embodiments, the homogenization is performed at from about 50 to about 400 bar. According to some embodiments, homogenization is performed for from 2 to 120 minutes. According to the principles of the present invention, any homogenization stage and any homogenization pressure found to homogenize the compositions and products of the present invention are included. According to some embodiments, homogenization may be performed in two steps. Non-limiting examples are stage homogenizing at 50 or 60 bar and then at 200 bar. According to some embodiments, the composition is heated prior to homogenization, e.g. heated up to 50° C. or up to 60° C. or up to 70° C.

According to some embodiments, the pasteurization is performed at a temperature of less than 100° C., at times, less than 90° C.; at times, less than 80° C. In some examples, during pasteurization, the composition is mildly heated, typically at a temperature between 50° C. and 100° C.; at times at a temperature of between 50° C. and 90° C., or at a temperature of between 50° C. and 80° C. According to some embodiments, the composition is heated at a temperature of between 85° C. and 95° C. In some examples, pasteurization is carried out at a temperature of about 90° C. for several minutes. In some examples, pasteurization is carried out at a temperature range of 85° C. and 95° C., at times, at a temperature range of between about 87° C. and 93° C. According to some embodiments, the duration of pasteurization is typically between 1 and about 10 minutes, at times, between about 2 and 9 minutes, at times between about 2 and 8 minutes, at times between about 3 and 7 minutes or at times for about 5 minutes. According to some embodiments, the pasteurization is carried out at a temperature range of 80° C. to 90° C. for from 1 to 50 minutes. According to some embodiments, the pasteurization is followed by cooling the pasteurized composition to a temperature below 50° C., or below 40° C., or below 35° C., e.g., about 30° C. According to some embodiments, the pasteurization is followed by cooling the pasteurized composition to a temperature optimal for lactic acid bacteria growth. Thus, according to some embodiments, the pasteurization is followed by cooling the pasteurized composition to from 60 to 70° C.

According to any one of the above embodiments, the alternative dairy product obtained in step (iii) is selected from the group consisting of an alternative milk composition, an alternative yogurt composition, an alternative soft cheese composition, an alternative ice cream composition, and an alternative hard cheese composition. According to some embodiments, the alternative dairy product obtained in step (iii) is a yogurt composition. According to some embodiments, the alternative dairy product obtained in step (iii) is a milk composition.

The methods of the present invention comprise hydrolyzing BLG protein and allow obtaining an alternative dairy product having modulated characteristics in comparison to a corresponding alternative dairy product prepared by a method that does not include a step of hydrolyzing BLG protein. Therefore, the resulting dairy product has one or more modulated characteristic in comparison to a corresponding characteristic in a corresponding dairy product comprising a BLG protein and substantially devoid of a BLG hydrolysate.

The terms “devoid”, “does not include” and “does not comprise” may be used interchangeably and refer to a composition that does not include, contain or comprise a particular component, e.g., said composition comprises less than 0.1 wt %, less than 0.01 wt %, or less than 0.001 wt % of the component.

According to some embodiments, the modulated characteristic of the alternative dairy product obtained in step (iii) is selected from: (i) Level of volatile sulfuric compounds (VSCs); (ii) Level of texture firmness; (iii) Level of texture consistency; (iv) Level of texture cohesiveness; (v) Level of texture work of cohesion; (vi) viscosity; (vii) Level of overall solubility of BLG protein and BLG hydrolysate; (viii) Level of the “L” value in the CIELAB color space; (ix) Level of the “a” value in the CIELAB color space; (x) Level of the “b” value in the CIELAB color space; (xi) Level of gel strength; (xii) pH, (xiii) degree of hydrolysis of BLG protein, and (xiv) any combination of (i) to (xiii).

According to some embodiments, the modulated characteristic of the alternative dairy product obtained in step (iii) is selected from the group consisting of (i) Decreased level of VSCs; (ii) Decreased level of texture firmness; (iii) Decreased level of texture consistency; (iv) Decreased level of texture cohesiveness; (v) Decreased level of texture work of cohesion; (vi) Increased or decreased level of texture viscosity; (vii) Increased overall solubility of BLG protein and BLG hydrolysate; (viii) Increased or decreased level of the “L” value in the CIELAB color space; (ix) Increased or decreased level of the “a” value in the CIELAB color space; (x) Increased or decreased level of the “b” value in the CIELAB color space (xi) Decreased gel strength; (xii) Decreased pH; (xiii) increased DH of BLG protein and/or hydrolysate thereof, (xiv) increased level of BLG hydrolysate, and (xi) any combination of (i) to (xiii).

According to some embodiments, the method results in formation of hydrolysate of BLG protein in the resulting alternative dairy product. According to some embodiments, the method increases the DH in the resulting dairy product in comparison to the corresponding alternative dairy product. According to some embodiments, the method decreases the level of VSCs in the resulting dairy product in comparison to the corresponding dairy product. According to some embodiments, the method decreases the level of texture firmness in the resulting dairy product in comparison to the corresponding dairy product. According to some embodiments, the method decreases the level of texture consistency in the resulting dairy product in comparison to the corresponding dairy product. According to some embodiments, the method decreases the level of texture cohesiveness in the resulting dairy product in comparison to corresponding dairy product. According to some embodiments, the method decreases the level of texture work of cohesion in the resulting dairy product in comparison to the corresponding dairy product. With respect to the terms “level of texture cohesiveness” and “level of texture work of cohesion”, the level, i.e. values, refer to the absolute numbers of these parameters; therefore, for example, the change from −100% to −50% is considered as a reduction (decrease) in the level of these parameters. According to some embodiments, the method decreases the viscosity in the resulting dairy product in comparison to the corresponding dairy product. According to some embodiments, the method increases the overall solubility of BLG protein and BLG hydrolysate in the resulting dairy product in comparison to the corresponding dairy product. According to some embodiments, the method increases the level of the “L” value in the CIELAB color space in the resulting dairy product in comparison to the corresponding dairy product. According to some embodiments, the method decreases the level of the “L” value in the CIELAB color space in the resulting dairy product in comparison to the corresponding dairy product. According to some embodiments, the method increases the level of the “a” value in the CIELAB color space in the resulting dairy product in comparison to the corresponding dairy product. According to some embodiments, the method decreases the level of the “a” value in the CIELAB color space in the resulting dairy product in comparison to the corresponding dairy product. According to some embodiments, the method increases the level of the “b” value in the CIELAB color space in the resulting dairy product in comparison to the corresponding dairy product. According to some embodiments, the method decreases the level of the “b” value in the CIELAB color space in the resulting dairy product in comparison to the corresponding dairy product. According to some embodiments, the method decreases the level of gel strength in the resulting dairy product in comparison to the corresponding dairy product. According to some embodiments, the method decreases the pH in the resulting dairy product in comparison to the corresponding dairy product.

According to some embodiments, the method does not affect/modulate at least one characteristic selected from the group consisting of buffering capacity, color measured as ΔE, foaming stability and foaming capacity, in comparison to the corresponding dairy product. According to some embodiments, the method does not modulate the buffering capacity of the resulting composition. According to some embodiments, the method does not modulate the color measured as ΔE of the resulting composition. According to some embodiments, the method does not modulate the foaming stability of the resulting composition. According to some embodiments, the method does not modulate the foaming capacity of the resulting composition. According to some embodiments, the method does not modulate any of the following characteristics: buffering capacity, color measured as ΔE, foaming stability and foaming capacity.

According to some embodiments, the BLG protein or all the BLG hydrolysate in the alternative dairy product obtained in step (iii) are present or obtained, respectively, in step (ii). According to some embodiments, all the BLG protein and all the BLG hydrolysate in the alternative dairy product obtained in step (iii) are present and obtained, respectively, in step (ii).

According to some embodiments, the amount of BLG protein and BLG hydrolysate collectively equals to the amount of BLG protein in the corresponding dairy product.

According to some embodiment, the BLG protein is a recombinant BLG protein (rBLG). According to some embodiments, the recombinant dairy protein is BLG (rBLG), produced in yeasts. According to some embodiments, the recombinant dairy protein is BLG produced in Pichia pastoris.

According to some embodiments, the method further comprises filling the resulting alternative product into a final container after the addition of the LAB, optionally without waiting for LAB fermentation. According to some embodiments, the filling is performed after the completion of step (v), e.g., in an alternative optional step (iv). According to some embodiments, filling the alternative product into a final container is performed in aseptic conditions. According to some embodiments, after pasteurization, all steps are performed in aseptic conditions.

According to any one of the above embodiments, no additional milk protein except for BLG protein and BLG hydrolysate is added during the preparation of the alternative dairy product. According to some embodiments, no additional whey protein except for BLG protein and BLG hydrolysate is added during the preparation of the alternative dairy product. According to some embodiments, no protein obtained from mammalian milk is added during the preparation of the alternative dairy product. According to some embodiments, no casein protein is added during the preparation of the alternative dairy product. According to some embodiments, no casein protein is added at the concentration in which casein is present in mammalian milk during the preparation of the alternative dairy product.

According to some embodiments, the BLG protein and the BLG hydrolysate are the only dairy protein and dairy protein hydrolysate, respectively, in the resulting alternative dairy product. According to some embodiments, the BLG protein and the BLG hydrolysate are the only whey protein and whey protein hydrolysate, respectively, in the resulting alternative dairy product. According to some embodiments, the BLG protein and the BLG hydrolysate are the only protein and protein hydrolysate, respectively, in the resulting alternative dairy product. According to some embodiments, the BLG protein and the BLG hydrolysate are the only polypeptides in the resulting alternative dairy product. According to some embodiments, the BLG protein and the BLG hydrolysate are the only source of amino acids in the resulting alternative dairy product.

According to another aspect, the present invention provides an alternative dairy product prepared by the method according to any one of the above embodiments and aspects. According to some embodiments, the alternative dairy product has one or more modulated characteristics in comparison to a corresponding dairy product as defined hereinabove. According to some embodiments, the corresponding dairy product (a) comprises the same level of BLG proteins as in the composition of step (i), (b) is produced without the partial hydrolysis step in step (ii), or (c) comprises a BLG protein and substantially devoid of a BLG hydrolysate. In certain embodiments, the corresponding dairy product comprises the same level of BLG proteins as in the composition of step (i). In certain embodiments, the corresponding dairy product is produced without the partial hydrolysis step in step (ii). In certain embodiments, the corresponding dairy product is substantially devoid of a BLG hydrolysate. In certain embodiments, the corresponding dairy product (a) comprises the same level of BLG proteins as in the composition of step (i), (b) is produced without the partial hydrolysis step in step (ii), and (c) comprises a BLG protein and substantially devoid of a BLG hydrolysate. According to some embodiments, the alternative dairy product prepared by the method according to any one of the above embodiments has properties as described hereinbelow.

According to another aspect, the present invention provides an alternative dairy product comprising a beta-lactoglobulin (BLG) protein and a BLG hydrolysate. All terms, embodiments, and definitions disclosed in any one of the above aspects apply and are encompassed herein as well. According to some embodiments, the alternative dairy product is an alternative dairy product.

According to some embodiments, the alternative dairy product comprises at least 0.1% w/w BLG protein. According to some embodiments, the alternative dairy product comprises from 0.1% w/w to 5% w/w of BLG protein. According to some embodiments, the alternative dairy product comprises from about 0.5% w/w to about 9.5% w/w, from about 1.0% w/w to about 9.0% w/w, from about 1.5% w/w to about 8.5% w/w, from about 2.0% w/w to about 8.0% w/w, from about 2.5% w/w to about 7.5% w/w, from about 3.0% w/w to about 7.0% w/w, from about 3.5% w/w to about 6.5% w/w, from about 4.0% w/w to about 6.0% w/w, from about 4.5% w/w to about 5.5% w/w, or about 5.0% w/w BLG. According to some embodiments, the alternative dairy product comprises from 0.1% w/w to 3% w/w of BLG protein. According to some embodiments, the alternative dairy product comprises from about 0.5% w/w to about 5% w/w, from about 1.0% w/w to about 4.5% w/w, from about 1.5% w/w to about 4.0% w/w, from about 2.0% w/w to about 3.5% w/w, or about 2.5% w/w BLG protein. According to some embodiments, the alternative dairy product comprises from 0.1% w/w to 1.5% w/w of BLG protein. According to some embodiments, the alternative dairy product comprises from about 0.1% w/w to about 1.5% w/w, from about 0.2% w/w to about 1.4% w/w, from about 0.3% w/w to about 1.3% w/w, from about 0.4% w/w to about 1.2% w/w, from about 0.5% w/w to about 1.1% w/w, from about 0.6% w/w to about 1.0% w/w, or from about 0.7% w/w to about 0.9% w/w of BLG protein. According to some embodiments, the alternative dairy product comprises about 0.1 w/w %, about 0.2 w/w %, about 0.3 w/w %, about 0.4 w/w %, about 0.5 w/w %, about 0.6 w/w %, about 0.7 w/w %, about 0.8 w/w %, about 0.9 w/w %, about 1.0 w/w %, about 1.1 w/w %, about 1.2 w/w %, about 1.3 w/w %, about 1.4 w/w %, about 1.5 w/w % of BLG protein.

According to some embodiments, the alternative dairy product comprises from 0.5% w/w to 9.5% w/w of BLG hydrolysate. According to some embodiments, the alternative dairy product comprises from about 0.5% w/w to about 9.5% w/w, from about 1.0% w/w to about 9.0% w/w, from about 1.5% w/w to about 8.5% w/w, from about 2.0% w/w to about 8.0% w/w, from about 2.5% w/w to about 7.5% w/w, from about 3.0% w/w to about 7.0% w/w, from about 3.5% w/w to about 6.5% w/w, from about 4.0% w/w to about 6.0% w/w, from about 4.5% w/w to about 5.5% w/w, or about 5.0% w/w BLG hydrolysate.

According to some embodiments, the alternative dairy product comprises from about 1.5% w/w to about 7.5% w/w, from about 2.0% w/w to about 7.0% w/w, from about 2.5% w/w to about 6.5% w/w, from about 3.0% w/w to about 6.0% w/w, from about 3.5% w/w to about 5.5% w/w, from about 4.0% w/w to about 5.0% w/w, or about 4.5% w/w of BLG hydrolysate.

According to some embodiments, the alternative dairy product comprises from 1% w/w to 5% w/w, from 1.2% w/w to 4.8% w/w, from 1.4% w/w to 4.6% w/w, from 1.6% w/w to 4.4% w/w, from 1.8% w/w to 4.2% w/w, from 2.0% w/w to 4.0% w/w, from 2.2% w/w to 3.8% w/w, from 2.4% w/w to 3.6% w/w, from 2.6% w/w to 3.4% w/w, from 2.8% w/w to 3.2% w/w, or about 3.0% w/w of BLG hydrolysate and from 1% w/w to 5% w/w, from 1.2% w/w to 4.8% w/w, from 1.4% w/w to 4.6% w/w, from 1.6% w/w to 4.4% w/w, from 1.8% w/w to 4.2% w/w, from 2.0% w/w to 4.0% w/w, from 2.2% w/w to 3.8% w/w, from 2.4% w/w to 3.6% w/w, from 2.6% w/w to 3.4% w/w, from 2.8% w/w to 3.2% w/w, or about 3.0% w/w of intact BLG protein. According to some embodiments, the alternative dairy product comprises from about 1.5% w/w to about 7.5% w/w of BLG hydrolysate and from 0.1% w/w to 7.5% w/w of BLG protein. According to some embodiments, the alternative dairy product comprises from about 1.5% w/w to about 5% w/w of BLG hydrolysate and from 0.1% w/w to 5% w/w of BLG protein. According to some embodiments, the alternative dairy product comprises from about 1.5% w/w to about 7.5% w/w of BLG hydrolysate and from 0.1% w/w to 3% w/w of BLG protein.

According to some embodiments, the BLG hydrolysate has a Degree of Hydrolysis (DH) of at least 0.5%. According to some embodiments, the BLG hydrolysate has a Degree of Hydrolysis (DH) of at least 1%. According to some embodiments, the BLG hydrolysate has a Degree of Hydrolysis (DH) of at least 1.5%. According to some embodiments, the BLG hydrolysate has a DH of 1% to 9%. According to some embodiments, the BLG hydrolysate has a DH of from 1% to 8%, from 1.1 to 7%, from 1.2 to 6%, from 1.3 to 5%, from 1.5 to 4%, from 1.6 to 3%, from 1.8 to 2.8%, from 2 to 2.5%. According to some embodiments, the BLG hydrolysate has a DH of from 0.7% to 3%, from 0.8% to 2.9%, from 1% to 3%, from 1.1 to 2.8%, from 1.2 to 2.5%, from 1.3 to 2.4%, from 1.4 to 2.3%, from 1.5 to 2.2%, from 1.8 to 2.4%, or from 1.8 to 2.3%. According to some embodiments, the BLG hydrolysate has a DH of about 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3% or 2.4%. According to some embodiments, the BLG hydrolysate has a DH of from 1.5% to 2.4%.

According to some embodiments, the weight ratio between the BLG protein and the BLG hydrolysate in the alternative dairy product is from about 99:1 to about 1:99, from 95:5 to 5:95, from 90:1 to 1:90, from 80:1 to 1:80, from 70:1 to 1:70, from 60:1 to 1:60, from 50:1 to 1:50, from 40:1 to 1:40, from 30:1 to 1:30, from 20:1 to 1:20, or from 15:1 to 1:15. According to some embodiments, the weight ratio between the BLG protein and the BLG hydrolysate is from about 10:1 to about 1:10, from about 9:1 to about 1:9, from about 8:1 to about 1:8, from about 7:1 to about 1:7, from about 6:1 to about 1:6, from about 5:1 to about 1:5, from about 4:1 to about 1:4, from about 3:1 to about 1:3, from about 2:1 to about 1:2, or about 1:1. According to some embodiments, the weight ratio between the BLG protein and the BLG hydrolysate is from about 1:3 to about 1:7. According to some embodiments, the weight ratio between the BLG protein and the BLG hydrolysate is from about 1:4 to about 1:6, respectively. According to some embodiments, the weight ratio between the BLG protein and the BLG hydrolysate is from about 1:2 to about 2:1, respectively. According to some embodiments, the weight ratio between the BLG protein and the BLG hydrolysate is from about 1:2 to about 3:1, respectively. According to some embodiments, the weight ratio between the BLG protein and the BLG hydrolysate is from about 3:1 to 1:3, or from about 3:2 to about 2:3.

According to some embodiments, the alternative dairy product comprises from about 1.5% w/w to about 7.5% w/w of BLG hydrolysate and from 0.1% w/w to 7.5% w/w of BLG protein. According to some embodiments, the alternative dairy product comprises from about 1.5% w/w to about 5% w/w of BLG hydrolysate and from 0.1% w/w to 5% w/w of BLG protein. According to some embodiments, the alternative dairy product comprises from about 1.5% w/w to about 7.5% w/w of BLG hydrolysate and from 0.1% w/w to 3% w/w of BLG protein. According to some embodiments, the weight ratio between the BLG protein and the BLG hydrolysate is from about 10:1 to about 1:10, from about 9:1 to about 1:9, from about 8:1 to about 1:8, from about 7:1 to about 1:7, from about 6:1 to about 1:6, from about 5:1 to about 1:5, from about 4:1 to about 1:4, from about 3:1 to about 1:3, from about 2:1 to about 1:2, or about 1:1. According to some embodiments, the alternative dairy product comprises from 1% w/w to 5% w/w of BLG hydrolysate, from 1% w/w to 5% w/w of intact BLG protein and the weight ratio between the BLG protein and the BLG hydrolysate is from about 5:1 to about 1:5, from about 4:1 to about 1:4, from about 3:1 to about 1:3, from about 2:1 to about 1:2, or about 1:1, and the BLG hydrolysate has a DH of from 0.7% to 3%, from 0.8% to 2.9%, from 1% to 3%, from 1.1 to 2.8%, from 1.2 to 2.5%, from 1.3 to 2.4%, from 1.4 to 2.3%, from 1.5 to 2.2%, from 1.8 to 2.4%, or from 1.8 to 2.3%.

According to some embodiments, the alternative dairy product of the present invention further comprises a lipid, a mineral, a salt, a sugar, lactic acid bacteria (LAB) or residuals thereof, or any combination thereof, as described in any one of the above aspects and embodiments. According to some embodiments, the alternative dairy comprises a lipid, a mineral, a salt, a sugar, and LAB, or residuals thereof. According to some embodiments, the LAB is Lactobacillus Bulgaricus. According to some embodiments, the LAB is Streptococcus Thermophilus. According to some embodiments, the LAB is a combination of Lactobacillus Bulgaricus and Streptococcus Thermophilus. According to some embodiments, the lipid is a non-animal lipid. According to some embodiments, the lipids comprise an oil. According to some embodiment, the oil is selected from shea oil, sunflower oil, coconut oil, rapeseed oil, nut oil, palm oil, kernel oil, olive oil, soya oil, cotton oil, and cocoa butter (Theobroma oil). According to some embodiments, the alternative dairy product comprises from 1 to 40 wt % of the non-animal lipid. According to some embodiments, the alternative dairy product comprises from 1 to 10 wt % of the non-animal lipid. According to some embodiments, the alternative dairy product comprises from 10 to 40 wt %, from 15 to 35 wt % or from 20 to 30 wt % of the non-animal lipid such as plant oil. According to some embodiments, the alternative dairy product comprises from 1 to 20 wt %, from 1 to 15 wt %, from 1 to 10 wt % or from 1 to 5 wt % of sugar. According to some embodiments, the alternative dairy product comprises from 1 to 5%, from 2 to 4 or about 3.2% of sugar. According to some embodiments, the sugar is selected from glucose, fructose, mannose, xylose, arabinose, sucrose, dextrose, maltose, and galactose. According to some embodiments, the sugar is dextrose. According to some embodiments, the alternative dairy product comprises a stabilizer. According to some embodiments, the alternative dairy product comprises a chelating agent. According to some embodiments, the alternative dairy product comprises a chelating agent. According to some embodiments, the alternative dairy product comprises a mineral such as a coagulation mineral. According to some embodiments, the alternative dairy product comprises from about 0.0015 to about 0.35 wt % of a coagulation mineral salt(s). According to some embodiments, the alternative dairy product comprises from about 0.002 to about 0.30 wt % of a coagulation mineral salt(s). According to some embodiments, the alternative dairy product comprises from about 0.005 to about 0.25 wt % of a coagulation mineral salt(s). According to some embodiments, the alternative dairy product comprises from about 0.01 to about 0.20 wt % of a coagulation mineral salt(s). According to some embodiments, the alternative dairy product comprises from about 0.05 to about 0.2 wt % of a coagulation mineral salt(s). According to some embodiments, the alternative dairy product comprises from about 0.1 to about 0.25 wt % of a coagulation mineral salt(s). According to some embodiments, the coagulation mineral salt is calcium chloride. According to some embodiments, the alternative dairy product comprises a salt such as sodium chloride. According to some embodiments, the alternative dairy product comprises a yeast extract. According to some embodiments, the alternative dairy product comprises from 0.005 to 0.5 wt % of yeast extract. According to some embodiments, the alternative dairy product comprises from 0.01 to 0.45 wt %, from 0.015 to 0.4 wt %, from 0.02 to 0.35 wt %, from 0.025 to 0.3 wt %, from 0.01 to 0.08 wt %, from 0.01 to 0.07 wt %, from 0.01 to 0.06 wt %, from 0.015 to 0.05 wt %, from 0.02 to 0.04 wt %, or about 0.03 wt % of yeast extract.

According to some embodiments, the alternative dairy product is a homogenized product. According to some embodiments, the alternative dairy product is a pasteurized dairy product. According to some embodiments, the alternative dairy product is a homogenized and pasteurized dairy product.

According to some embodiments, the alternative dairy product is selected from the group consisting of an alternative milk composition, an alternative yogurt composition, an alternative soft cheese composition, an alternative ice cream composition, and an alternative hard cheese composition.

According to some embodiments, the alternative dairy product is an alternative milk. According to some embodiments, the alternative dairy product is an alternative yogurt composition.

According to some embodiments, the BLG protein and the BLG hydrolysate are the only dairy protein and dairy protein hydrolysate, respectively, in the alternative dairy product. According to some embodiments, the BLG protein and the BLG hydrolysate are the only whey protein and whey protein hydrolysate, respectively, in the alternative dairy product. According to some embodiments, the BLG protein and the BLG hydrolysate are the only protein and protein hydrolysate, respectively, in the alternative dairy product. According to some embodiments, the BLG protein and the BLG hydrolysate are the only polypeptides in the alternative dairy product. According to some embodiments, the BLG protein and the BLG hydrolysate are the only source of amino acids in the alternative dairy product.

According to some embodiments, the alternative dairy product of the present invention has at least one modulated characteristic in comparison to a corresponding characteristic in a corresponding alternative dairy product comprising BLG protein as defined herein above.

In some embodiments, the collective amount of BLG protein and BLG hydrolysate in the alternative dairy product is substantially equal to the amount of BLG protein in the corresponding dairy product which is devoid of a BLG hydrolysate.

According to some embodiments, the modulated characteristic of the alternative dairy product is selected from (i) Level of volatile sulfuric compounds (VSCs); (ii) Level of texture firmness; (iii) Level of texture consistency; (iv) Level of texture cohesiveness; (v) Level of texture work of cohesion; (vi) viscosity; (vii) solubility of BLG protein and BLG hydrolysate; (viii) Level of the “L” value in the CIELAB color space; (ix) Level of the “a” value in the CIELAB color space; (x) Level of the “b” value in the CIELAB color space; (xi) gel strength; (xii) pH, (xiii) degree of hydrolysis of BLG protein, (xiv) level of BLG hydrolysate, and (xv) any combination of (i) to (xiv).

According to some embodiments, the modulated characteristic of the alternative dairy product is selected from the group consisting of (i) Decreased level of VSCs; (ii) Decreased level of texture firmness; (iii) Decreased level of texture consistency; (iv) Decreased level of texture cohesiveness; (v) Decreased level of texture work of cohesion; (vi) Increased or decreased viscosity; (vii) Increased level of overall solubility of BLG protein and BLG hydrolysate (viii) Increased or decreased level of the “L” value in the CIELAB color space; (ix) Increased or decreased level of the “a” value in the CIELAB color space; (x) Increased or decreased level of the “b” value in the CIELAB color space (xi) Decreased level of gel strength; (xii) Decreased pH; (xiii) increased degree of hydrolysis of BLG protein, (xiv) increased level of BLG hydrolysate, and (xv) any combination of (i) to (xiv).

According to some embodiments, the alternative dairy product of the present invention has an increased DH in comparison to the corresponding alternative dairy product. According to some embodiments, the alternative dairy product of the present invention has an increased level/amount of BLG hydrolysate in comparison to the corresponding alternative dairy product. According to some embodiments, the alternative dairy product of the present invention has a decreased level of VSCs in comparison to the corresponding dairy product. According to some embodiments, the alternative dairy product has a decreased level of texture firmness in the resulting dairy product in comparison to the corresponding dairy product. According to some embodiments, the alternative dairy product has a decreased level of texture consistency in the resulting dairy product in comparison to the corresponding dairy product. According to some embodiments, the alternative dairy product has a decreased level of texture cohesiveness in the resulting dairy product in comparison to the corresponding dairy product. According to some embodiments, the alternative dairy product has a decreased level of texture work of cohesion in comparison to the corresponding dairy product. According to some embodiments, the alternative dairy product has a decreased level of texture viscosity in the resulting dairy product in comparison to the corresponding dairy product. According to some embodiments, the alternative dairy product has an increased level of overall solubility of BLG protein and BLG hydrolysate in the resulting dairy product in comparison to the corresponding dairy product. According to some embodiments, the alternative dairy product has an Increased level of the “L” value in the CIELAB color space in the resulting dairy product in comparison to the corresponding dairy product. According to some embodiments, the alternative dairy product has a decreased level of the “L” value in the CIELAB color space in the resulting dairy product in comparison to the corresponding dairy product. According to some embodiments, the alternative dairy product has an increased level of the “a” value in the CIELAB color space in the resulting dairy product in comparison to the corresponding dairy product. According to some embodiments, the alternative dairy product has a decreased level of the “a” value in the CIELAB color space in the resulting dairy product in comparison to the corresponding dairy product. According to some embodiments, the alternative dairy product has an Increased level of the “b” value in the CIELAB color space in the resulting dairy product in comparison to the corresponding dairy product. According to some embodiments, the alternative dairy product has a decreased level of the “b” value in the CIELAB color space in the resulting dairy product in comparison to the corresponding dairy product. According to some embodiments, the alternative dairy product has a Decreased level of gel strength in the resulting dairy product in comparison to the corresponding dairy product. According to some embodiments, the alternative dairy product has a Decreased pH in the resulting dairy product in comparison to the corresponding dairy product.

According to some embodiments, the alternative dairy product of the present invention has at least one characteristic selected from buffering capacity, color measured as ΔE, foaming stability and foaming capacity, similar or identical to the corresponding characteristic in a corresponding dairy product. According to some embodiments, the alternative dairy product has a similar or identical buffering capacity as a corresponding dairy product. According to some embodiments, the alternative dairy product has a similar or identical color measured as ΔE as a corresponding dairy product. According to some embodiments, the alternative dairy product has a similar or identical foaming stability as a corresponding dairy product. According to some embodiments, the alternative dairy product has a similar or identical foaming capacity as a corresponding dairy product.

According to some embodiments, all of the buffering capacity, the color measured as ΔE, the foaming stability and the foaming capacity of the alternative dairy product are similar or identical to the corresponding characteristic in a corresponding dairy product.

According to some embodiments, the alternative dairy product is a non-animal dairy product. According to some embodiments, the BLG protein is a recombinant BLG protein.

According to other embodiments, the alternative dairy product comprises from about 1 to about 4 wt % of BLG protein, from about 2 to about 6 wt % of BLG hydrolysate, from about 1 to about 6 wt % of the non-animal lipid; and from about 2 to about 15 wt % of the sugar. According to other embodiments, the alternative dairy product further comprises from about 0.05 to about 0.3 wt % of the stabilizer and/or LAB.

According to any one of the above embodiments, the alternative dairy product does not contain any additional milk protein aside from BLG protein and BLG hydrolysate. According to some embodiments, the alternative dairy product does not contain any whey protein aside from BLG protein and BLG hydrolysate. According to some embodiments, the alternative dairy product does not contain any protein obtained from mammalian milk. According to some embodiments, the alternative dairy product does not contain a casein protein. According to some embodiments, the alternative dairy product does not contain a casein protein at the concentration casein present in mammalian milk during the preparation of the alternative dairy product.

According to another aspect, the present invention provides a method for preparing an alternative dairy product with a modulated characteristic comprising a beta-lactoglobulin (BLG) protein, the method comprising the steps of:
(i) obtaining a composition comprising BLG proteins,
(ii) mixing the composition of step (i) with a BLG hydrolysate, and
(iii) formulating the composition obtained in step (ii) into an alternative dairy product, thus obtaining the alternative dairy product with a modulated characteristic, wherein the characteristic is modulated in comparison to a corresponding characteristic in a corresponding dairy product as defined hereinabove. According to some embodiments, the corresponding dairy product (a) comprises the same level of BLG proteins as in the composition of step (i), (b) is produced without the partial hydrolysis step in step (ii), or (c) is substantially devoid of a BLG hydrolysate.

In certain embodiments, the corresponding dairy product comprises the same level of BLG proteins as in the composition of step (i). In certain embodiments, the corresponding dairy product is produced without the partial hydrolysis step in step (ii). In certain embodiments, the corresponding dairy product is substantially devoid of a BLG hydrolysate. In certain embodiments, the corresponding dairy product (a) comprises the same level of BLG proteins as in the composition of step (i), (b) is produced without the partial hydrolysis step in step (ii), and (c) is comprising a BLG protein and substantially devoid of a BLG hydrolysate.

All terms, embodiments and definitions disclosed in any one of the above aspects apply and are encompassed herein as well.

According to another aspect, the present invention provides a method for preparing an alternative dairy product with a modulated characteristic comprising a beta-lactoglobulin (BLG) protein, the method comprising the steps of:
(i) mixing a composition comprising BLG proteins with a composition comprising a BLG hydrolysate, and
(ii) formulating the composition obtained in step (i) into an alternative dairy product, thus obtaining the alternative dairy product with a modulated characteristic,
wherein the characteristic is modulated in comparison to a corresponding characteristic in a corresponding dairy product as defined hereinabove. According to some embodiments, the corresponding dairy product (a) comprises the same level of BLG proteins as in the composition of step (i), (b) is produced without the partial hydrolysis step in step (ii), or (c) is substantially devoid of a BLG hydrolysate.

In certain embodiments, the corresponding dairy product comprises the same level of BLG proteins as in the composition of step (i). In certain embodiments, the corresponding dairy product is produced without the partial hydrolysis step in step (ii). In certain embodiments, the corresponding dairy product is substantially devoid of a BLG hydrolysate. In certain embodiments, the corresponding dairy product (a) comprises the same level of BLG proteins as in the composition of step (i), (b) is produced without the partial hydrolysis step in step (ii), and (c) is comprising a BLG protein and substantially devoid of a BLG hydrolysate.

According to another aspect, the present invention provides a method for preparing an alternative dairy product with a modulated characteristic comprising a beta-lactoglobulin (BLG) protein, the method comprising the steps of:
(i) obtaining a composition comprising BLG proteins and a BLG hydrolysate, and
(ii) formulating the composition obtained in step (i) into an alternative dairy product, thus obtaining the alternative dairy product with a modulated characteristic,
wherein the characteristic is modulated in comparison to a corresponding characteristic in a corresponding dairy product as defined hereinabove. According to some embodiments, the corresponding dairy product (a) comprises the same level of BLG proteins as in the composition of step (i), (b) is produced without the partial hydrolysis step in step (ii), or (c) is substantially devoid of a BLG hydrolysate.

In certain embodiments, the corresponding dairy product comprises the same level of BLG proteins as in the composition of step (i). In certain embodiments, the corresponding dairy product is produced without the partial hydrolysis step in step (ii). In certain embodiments, the corresponding dairy product is substantially devoid of a BLG hydrolysate. In certain embodiments, the corresponding dairy product (a) comprises the same level of BLG proteins as in the composition of step (i), (b) is produced without the partial hydrolysis step in step (ii), and (c) is comprising a BLG protein and substantially devoid of a BLG hydrolysate.

All terms, embodiments and definitions disclosed in any one of the above aspects apply and are encompassed herein as well.

The terms “a,” “an,” and “the”” are used herein interchangeably and mean one or more. The term “and/or” is used to indicate one or both stated cases may occur, for example A and/or B includes, (A and B) and (A or B).

The term “or,” as used herein, denotes alternatives that may, where appropriate, be combined; that is, the term “or” includes each listed alternative separately as well as their combination if the combination is not mutually exclusive.

The terms “comprising”, “comprise(s)”, “include(s)”, “having”, “has” and “contain(s),” are used herein interchangeably and have the meaning of “consisting at least in part of”. When interpreting each statement in this specification that includes the term “comprising”, features other than that or those prefaced by the term may also be present. Related terms such as “comprise” and “comprises” are to be interpreted in the same manner. The terms “have”, “has”, having” and “comprising” may also encompass the meaning of “consisting of” and “consisting essentially of”, and may be substituted by these terms. The term “consisting of” excludes any component, step or procedure not specifically delineated or listed. The term “consisting essentially of” means that the composition or component may include additional ingredients, but only if the additional ingredients do not materially alter the basic and novel characteristics of the claimed compositions or methods.

As used herein, the terms “about”, “same” and “equal”, when referring to a measurable value such as an amount, a temporal duration, and the like, is meant to encompass variations of +/−10%, or +/−5%, +/−1%, or even +/−0.1% from the specified value.

Having now generally described the invention, the same will be more readily understood through reference to the following examples, which are provided by way of illustration and are not intended to be limiting of the present invention.

### EXAMPLES

### Materials

Recombinant bovine BLG. The recombinant bovine BLG has the amino acid sequence as set forth in SEQ ID NO:1. In some examples, the recombinant bovine BLG has the amino acid sequence as set forth in any one of SEQ ID NOs: 1-20. The following materials were purchased from Sigma Aldrich: Spectra™ Multicolor Low Range Protein Ladder (26628), Sodium hydroxide, Citric Acid, Calcium Chloride, Papain (from papaya latex CAS No. 9001-73-4 Sigma), Trypsin (Trypsin from bovine pancreas-CAS 9002-07-7), Ficin (from fig tree latex F4165), Bromelain pineapple stem (from pineapple stem, B4882), Alcalase (from Bacillus licheniformis, 126741). Novex Tris-Glycin 4-20%, 1.0 mm, Mini Protein Gel, ThermoFisher (for low molecular weight proteins/peptides), Novex™ Tricine SDS Running Buffer (10×), 4×SB+50 mM DTT (sample buffer+reducing agent), Instant blue Coomassie (Bio-Rad), Tri-Sodium Citrate (CHEN SAMUEL CHEMICALS).

### Example 1. Controlled Hydrolysis of BLG Using Alcalase, Ficin, Trypsin, Papain & Bromelain

Several protease enzymes were initially screened to evaluate their performance and effect on BLG and BLG-based yogurt prototype. This method was executed as following: recombinant BLG was weighed (5% w/w) and added with trisodium citrate (as a divalent ion chelator, 0.16% w/w) to deionized water (94.84% w/w) for 40 min at 40° C. to fully hydrate the protein. Next, the temperature was set to 50° C. and the pH was adjusted to pH=8.0 using NaOH. Subsequently, a protease (Alcalase or Ficin or Trypsin or Papain or Bromelain, 0.005% w/w) was added to the solution and pH was constantly monitored until reached pH=7.0. Once accomplished, the solution was heated for 5 min at 90° C. to fully inactivate the protease and immediately cooled on ice for 15 min. Finally, the solution was heated to 40° C. and the pH was set to pH=6.8 and aliquots were removed to test the gelation and solubility of the different enzymes at different degree of hydrolysis.

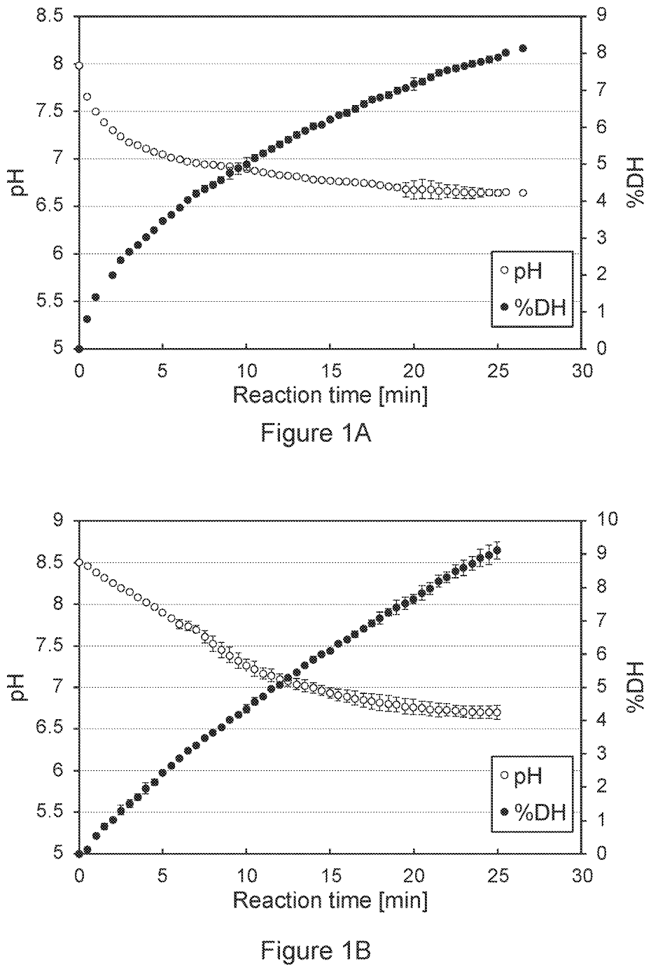

Based on results, Ficin and Alcalase were selected for further investigation and optimization. The enzymatic reaction was carried out in a similar manner as explained above with a few adjustments. For both Ficin and Alcalase, the reaction temperature was set to 55° C. and the enzyme: substrate ratio was modified to 1:200. For Ficin, the initial pH of the reaction was set to pH=8.0. For Alcalase, the initial pH was set to pH 8.5. The reaction was terminated at DH=~8% and aliquots were tasted by a trained panel to detect bitter notes caused by protein degradation/hydrolysis to smaller fragments. The results are presented in FIGS. 1A and 1B.

For both enzymes, the bitterness threshold was evaluated between 2.0-3.0% DH. Thus, yogurt products were done only using BLG hydrolyzed up to 3.0% DH.

Methods described herein were applied on two types of products: Alcalase/Ficin/Trypsin/Papain/Bromelain BLG-hydrolyzed solution (referred to as ‘solution’) and Alcalase/Ficin/Trypsin/Papain/Bromelain BLG-hydrolyzed gel (referred to as ‘gel’) to better mimic commercial products such as yogurt. To produce the gel, 100 μL of CaCl₂) solution (decreases coagulation time, creates firmer gels, and increases curd yield; 3 gr in 7 mL deionized water) was added to every 100 mL of hydrolyzed BLG solution. Next, Glucono delta-lactone (GDL, an acidifier; 0.5 gr per 100 mL solution) was directly added to the beaker and gently stirred.

### Example 2. Controlled Hydrolysis of BLG Using Alcalase

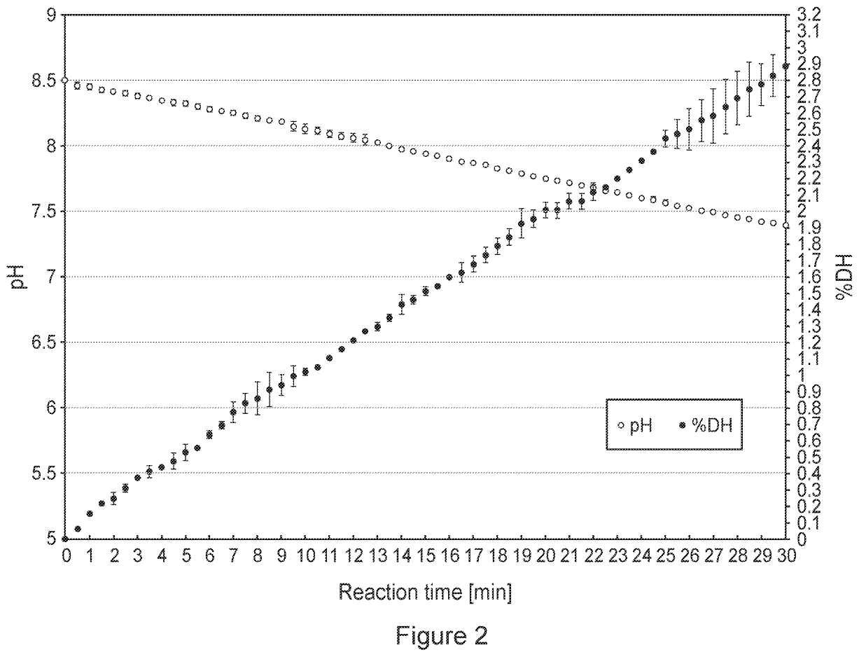

5% of recombinant BLG powder and 0.16% Trisodium citrate were added to distilled water and mixed at 440 rpm at 40° C. for 30 min. After full hydration, the solution was heated to 55° C. and the pH was adjusted to 8 with NaOH. Alcalase (from Bacillus licheniformis) was added at the enzyme: substrate ratio of 1:800. The reaction was terminated when the pH reached 7.0 by heating the solution to 90° C. for 5 min. Then the solution was cooled on ice to 40° C. and the pH was adjusted to 6.8 with citric acid. The pH was measured every 30 sec and the DH was calculated according to equation Number 1 as described above. The results are presented in FIG. 2.

In further examples, the reaction was terminated after 9, 17 and 24 min to achieve a degree of hydrolysis (DH) equivalent to approximately 0.85%, 1.6% and 2.3% based on equation Number 1. DH 0.85, 1.6 and 2.3% were chosen since DH above ~2.5% created bitter, undesirable off-notes. In addition, two controls were examined, 0% DH and an internal control (referred to as ‘control’). The first, 0% DH, did not contain Alcalase, yet did endure enzymatic heat inactivation as mentioned above. The second, control, did not contain Alcalase and was heated to 85° C. for 2 min, to mimic commercial pasteurization conditions. Subsequently, the solution was cooled on ice to 40° C. and the pH was adjusted to 6.8 with citric acid.

### Example 3. Controlled Hydrolysis of BLG Using Chymotrypsin

Recombinant BLG powder (20.48 gr) was hydrated in deionized water (364.06 gr) for 40 min at 440 rpm and 40° C. Next, the solution was heated for 15 min at 85° C. and immediately cooled in ice for 15 min. This pre-stage is aimed to induce BLG desaturation and increase protein hydrolysis. Chymotrypsin (40 mg) was mixed with 200 μl of deionized water and 100 μl were added to the BLG solution (the enzyme to substrate ratio was set to 1:800 w/w). The enzymatic reaction was set at 40° C. at pH=7.5. During the reaction, the pH was constantly monitored and set adjusted to pH=7.5 using NaOH (the amount of NaOH added was recorded). The enzymatic reaction was deactivated after 5, 10 and 15 min as following: 96.14 gr were removed and to a 250 mL glass beaker. The solution was heated to 60° C. for 20 minutes while stirred at 150 rpm. Subsequently, the solution was cooled on ice and kept at 4° C. for 24 hours for yogurt preparation. The DH was measured based on Equation Number 1. The results are presented in Table 1 below.

TABLE 1

| | NaOH consumption [μl] | DH [%] |
|---|---|---|
| 5 min hydrolysis | 150 | 0.78 |
| 10 min hydrolysis | 420 | 1.19 |
| 15 min hydrolysis | 350 | 1.82 |

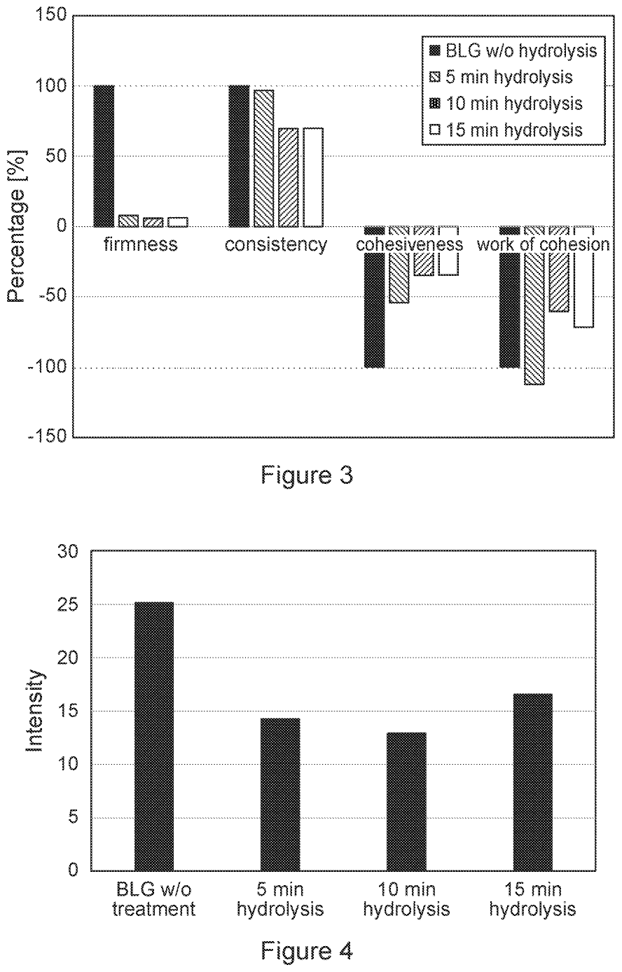

Methods described herein were applied on two types of products: alpha-Chymotrypsin BLG-hydrolyzed solution (referred to as ‘solution’) and alpha-Chymotrypsin BLG-hydrolyzed gel (referred to as ‘gel’) to better mimic commercial products such as yogurt. To produce the gel, hydrolyzed BLG solutions were mixed for 30 min at 40° C. with 3.42% dextrose (sugar), 0.15% partly amidated low ester pectin (texture stabilizer, GENU® Pectin type LM-106 AS-YA), and 0.053% yeast extract (culture growth supporter, NuCel® 582 MG-Powder). Next, the samples were dispersed using an T 25 digital ULTRA-TURRAX for 30 sec at 5,000 rpm and pH was adjusted to pH=6.8. The solution was heated at 85° C. for 2 min and immediately cooled on ice for 15 min. Finally, Vegan culture (VEGA™ Harmony, CHR Hansen, 0.027%) and CaCl₂) (decreases coagulation time, creates firmer gels, and increases curd yield; 0.07%) were added to the solution and the mixture was incubated at 38° C. overnight. The effect of hydrolysis on several properties was tested and presented in FIG. 3. It can be seen that BLG hydrolysis using Chymotrypsin drastically reduced the firmness of the gel, and had a moderate effect of consistency, especially at higher hydrolysis time. Hydrolysis also decreased the cohesiveness of the gel (about 2 times) for any tested hydrolysis time and work of cohesion for higher hydrolysis time (10 and 15 mins).

### Example 4. Smell Evaluation Using Electronic Nose Analysis

The volatile sulfuric compounds arising from the hydrolyzed BLG gels after 5, 10 and 15 min reaction with alpha-Chymotrypsin (as elaborated in Example 2) were measured using a portable electronic nose (PEN 3, Airsense Analytics GmbH, Germany). Prior to the analysis, 12 mL of the samples were inserted into a closed glass tube and incubated for 30 min at 50° C. to induce the volatile compounds. Results shown in FIG. 4 present organic-sulfur smell intensity as detected by metal oxide sensors. The flow rate was set to 300 mL/min during the measurement. After each test, the sensors were flushed with fresh air for 180 sec. Electronic nose analysis of each sample was repeated four times. It can be seen that the intensity of organic sulfur volatiles reduced significantly (by about 40%) in BLG-hydrolyzed samples.

### Example 5. Semi-Quantitative Analysis of Products of BLG Hydrolysis

### SDS-PAGE Analysis & ImageJ Quantification

The evaluation of peptide liberation during the controlled hydrolysis of BLG was performed via SDS-PAGE analysis. Briefly, 10 μL of each sample (for Alcalase: DH 0, 0.85, 1.6, 2.3% and control; for Chymotrypsin: DH 0.78, 1.19, 1.82 and BLG control as described above) was diluted in 440 μL deionized water. Next, 30 μL of the solution was mixed with 10 μL 4×SB+50 mM DTT (sample buffer+reducing agent), vortexed, heated for 5 min at 95° C. and 15 μL were mixed with 5 μL Spectra™ Multicolor Low Range Protein Ladder. The sample was loaded to a Novex Tris-Glycin 4-20%, 1.0 mm, Mini Protein Gel, ThermoFisher (for low molecular weight proteins/peptides) and set to run for 40 min at 200V. Gels were stained using Instant blue Coomassie and the deconvolved images were then processed in the ‘ImageJ-FIJI’ software (National Institutes of Health, USA) for band quantification.

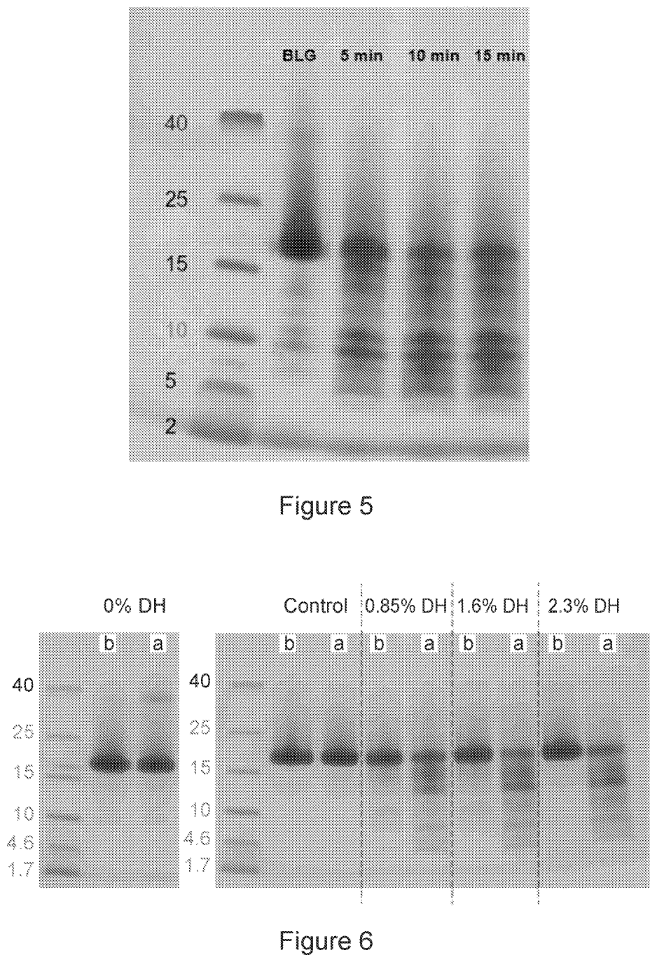

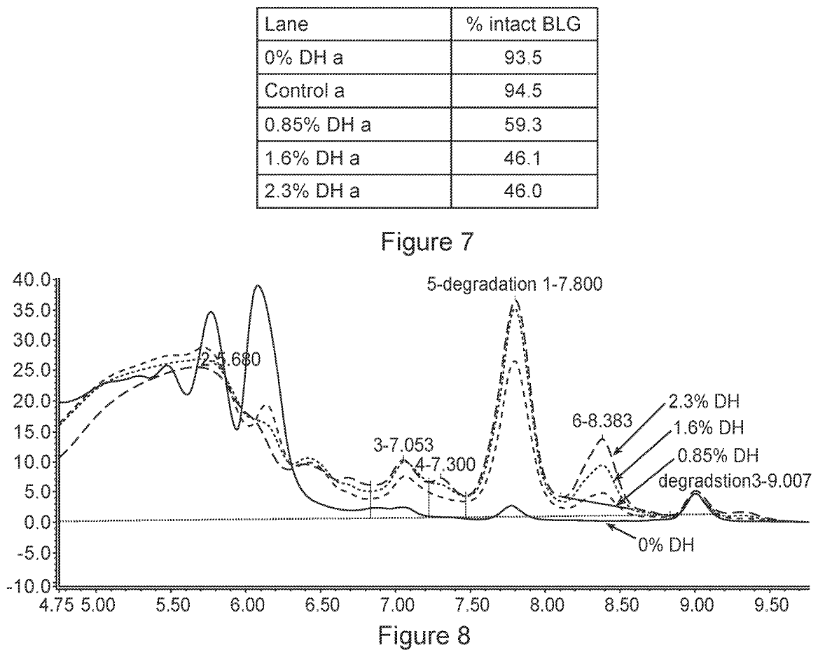

The results for Chymotrpsyin are presented in FIG. 5 and for Alcalase in FIG. 6A. FIG. 7 shows the percent of intact BLG after hydrolysis with Alcalase, presented also in Table 2.

TABLE 2
Correlation between percent of DH and remaining intact BLG.

| % DH | % intact BLG |
|---|---|
| 0% | 93.5 |
| 0.85% | 59.3 |
| 1.6% | 46.1 |
| 2.3% | 46.0 |

It can be seen that new bands of lower molecular weights appeared as a result of the controlled hydrolysis. In addition, it can be seen that at higher DH, the band of BLG dimer (18.4 kDa) weakens and low molecular weight bands appear, indication BLG breakdown.

### HPLC Analysis

To further understand the effect of BLG hydrolysis by Alcalase or alpha-Chymotrypsin on the overall peptide profile, samples (for Alcalase: DH 0%, 0.85%, 1.6%, 2.3%, and control; for Chymotrypsin: DH 0.78%, 1.19%, 1.82% and BLG control) were analyzed using HPLC. Briefly, samples were initially diluted tenfold using PBS and purified using 0.2 μm pore size filters. Next, samples were injected to HPLC (Thermo Fisher Scientific Vanquish Core HPLC system, US) using a PSS-Column and an isocratic mixture 20 mM phosphate buffer (pH=7.0) with 100 mM NaCl and 0.05% Sodium azide as the mobile phase at 1 ml/min flow rate and 25° C. Detector wavelength was set to be 280 nm.

The results for Alcalase in FIG. 7 and clearly demonstrate the hydrolysis of BLG and the appearance of peptides with a lower molecular weight. Similar results were obtained for a hydrolysis with chymotrypsin (data not shown).

### Example 6. Controlled Hydrolysis Effect on Texture

### Gel Strength

To evaluate the effect of controlled hydrolysis of BLG by Alcalase on gel strength the following procedure was executed.

Prior to incubation, the mixture was poured (23 mL) into texture analyzer Teflon cups to form the gel. Gel strength was measured using texture analyzer (Stable Micro Systems, TA.XTplusC, England) with a P/75 compression platen. Calibration settings were as follows: Return distance: 75 mm, Return speed 10 mm/see, Contact force: 50 kg. The parameters measured for all samples were firmness, consistency, cohesiveness, and work of adhesion. Gel strength parameters measurements were repeated three times for each sample in two individual repetitions (at least).

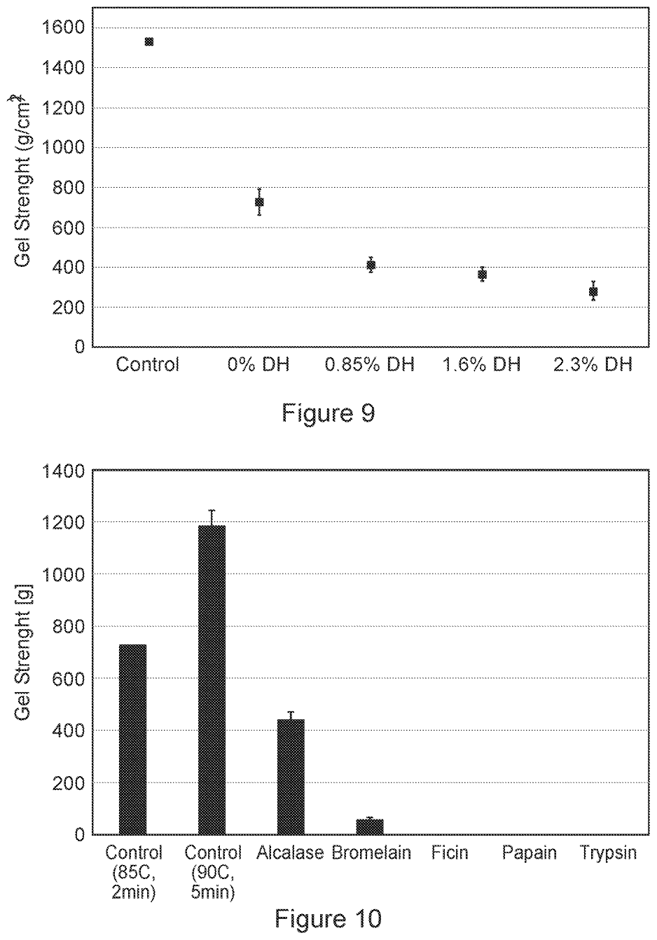

The results are presented in FIG. 9. It can be seen that heat treatment (inactivation at 90° C., 5 min) at high pH (above 8.5) decreases gel strength by 50% and alcalase hydrolysis further reduces the gel strength until reaching plateau at about 250 g/cm². A similar procedure was performed for samples obtained by hydrolysis of BLG with alpha-Chymotrypsin, Bromelain, Ficin, Papain and Trypsin. The results are presented in FIG. 10.

### Viscosity

The viscosity (cP) of the samples was measured for alcalase and alpha-Chymotrypsin as follows: Gel samples were dispersed using an T 25 digital ULTRA-TURRAX for 2 min at maximum speed (25,000 rpm). Subsequently, the samples (DH 0%, 0.85%, 1.6%, 2.3% for alcalase and control) were transferred to 50 mL plastic Falcons and stored at 4° C. overnight. The viscosity was measured using an IKA ROTAVISC SBS me-vi HELI Complete using a T-SP-SET spindle (3 rpm at 4° C.). Viscosity measurements were repeated three times for each sample in two individual repetitions (at least).

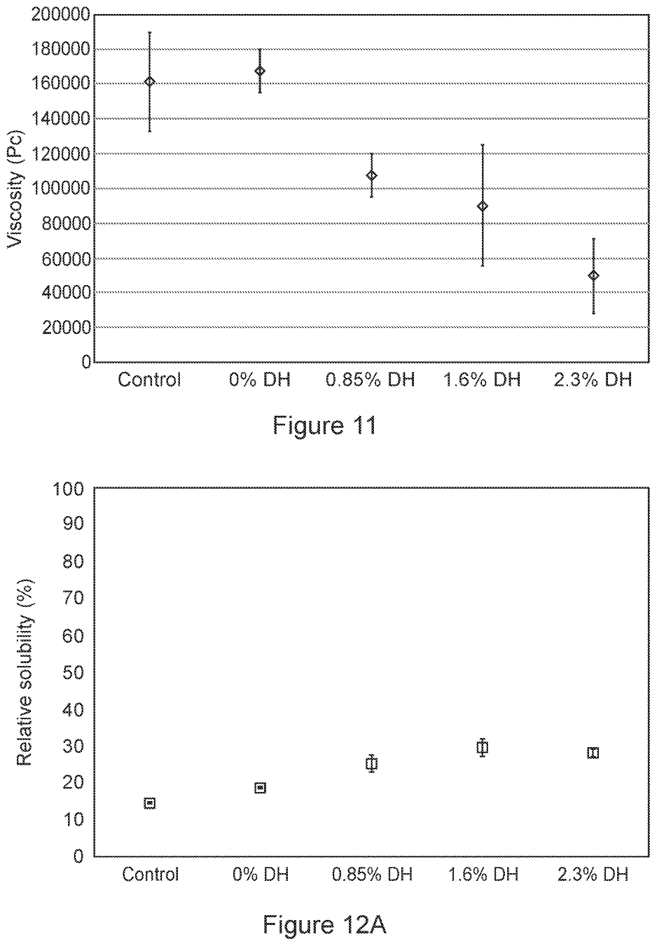

The results for alcalase are shown in FIG. 11 and clearly indicate the linear correlation between the DH and the reduction in viscosity. Results obtained for alpha-Chymotrypsin are shown in Table 2 below.

TABLE 2

| | BLG w/o | 5 min | 10 min | 15 min |
|---|---|---|---|---|
| | treatment | hydrolysis | hydrolysis | hydrolysis |
| Viscosity | 22-30 | 26-35 | 18-22 | 25-35 |
| [Pa · s] | | | | |

### Example 7. Relative Solubility and Buffer Capacity

To assess the effect of controlled hydrolysis of BLG on relative solubility and buffering capacity, the pH of the hydrolyzed solutions was adjusted to 4.5 at 40° C. with citric acid. The BLG hydrolyzed solutions were prepared as mentioned in Examples above, depending on the type of the protease method. For all proteases tested, the relative solubility and buffering capacity were tested as follows: Solution samples of 1 mL were collected and centrifuged at 18,200 g for 10 min at 25° C. to precipitate insoluble BLG. The concentration of soluble BLG in supernatant was assessed by Micro BCA Protein assay kit (Thermo Scientific, USA) using bovine serum albumin (BSA) as a standard. Briefly, the samples were diluted with phosphate-buffered saline to a ratio of 1:10 (samples that precipitated—pH=4, 4.5, 5.5) or 1:100 (samples highly soluble—pH=6.5). BSA standard curve was prepared by diluting a stock solution of 2 mg/mL BSA to: 0, 0.0625, 0.125, 0.25, 0.5, 1, 2 mg/mL. The final volume of each sample was equal to 35 μL. Next, 10 μL of each sample or standard was transferred to a 96-well plate (triplicate) and 200 μL of the BCA reagent mix (A:B in a ratio of 50:1) was added. The plate was incubated at room temperature (25° C.) for 30 minutes covered with aluminum foil and absorbance was read at 562 nm. Finally, the solubility was calculated according to equation Number 2:

$$solubility [ \% ] = \frac{protein in the supernatant}{protein in the initial solution} * 100 \% \qquad Equation Number 2$$

All measurements were repeated three times for each sample in two individual repetitions (at least).

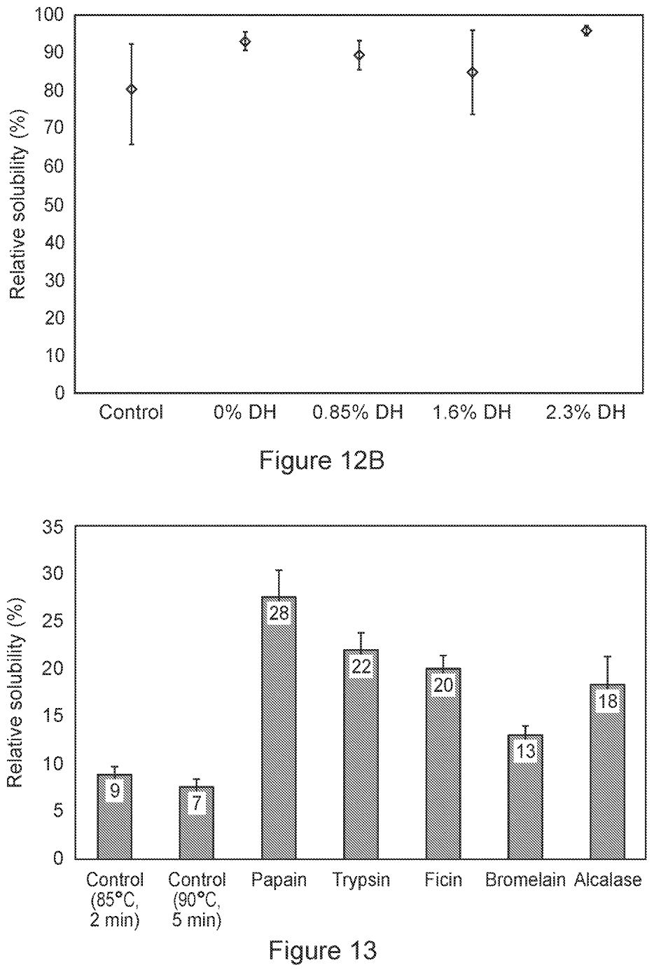

Solubility was calculated relative to BLG solubility of the specific sample at pH=8.5. The results for samples obtained upon alcalase hydrolysis are presented in FIG. 12A (at pH 5.3) and 12B (at pH 6). The results for samples obtained upon hydrolysis by several proteases are presented in FIG. 13.

It can be seen that a priory, solubility of BLG and hydrolysate is lower in lower pH. The controlled hydrolysis allows keeping more protein (BLG hydrolysate) in the solution in acidic conditions. This is especially important for acidic products such as yogurts.

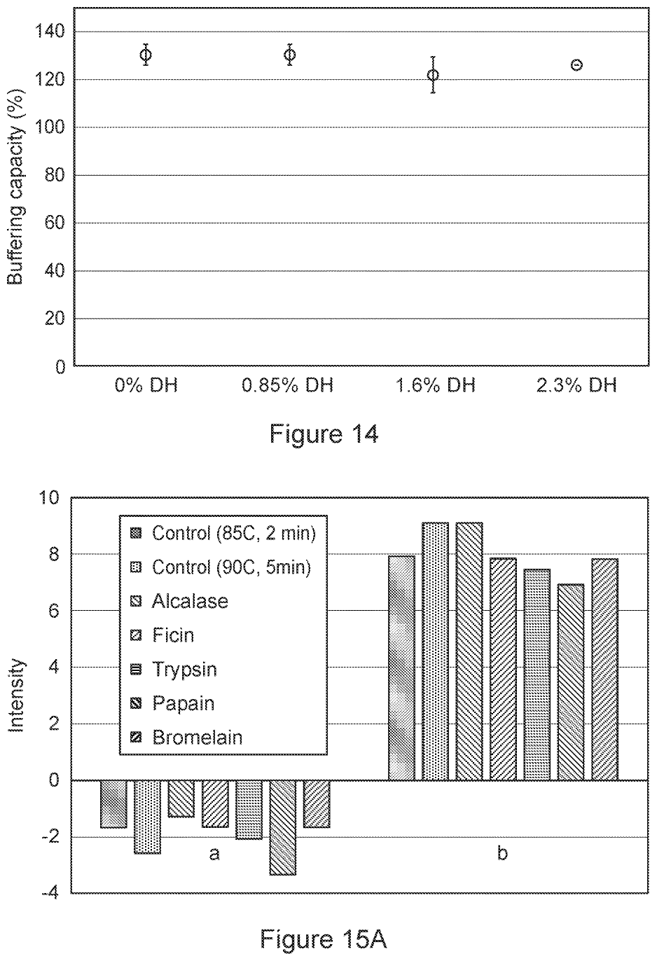

The results of buffering capacity for alcalase-hydrolyzed BLG are provided in FIG. 14. Average buffering capacity of pasteurized BLG solution (4%) is 100%. It can be seen that treatment (inactivation at 90° C., 5 min) combined with the addition of ions (NaOH and citric acid) increases buffering capacity of BLG by 30%. Hydrolysis of BLG did not affect its buffering capacity.

### Example 8. Gel Color

To evaluate the impact of BLG-controlled hydrolysis on color, the following procedure was executed for all tested proteases: Gel samples (DH 0%, 0.85%, 1.6%, 2.3% and control) were dispersed using an T 25 digital ULTRA-TURRAX for 2 min at maximum speed (25,000 rpm). Once dispersed, the samples were transferred to a designated measurement cell and placed on a benchtop colorimeter (CR5; Konica Minolta Bench-top, Japan) utilizing the CIE L*a*b* color space. All measurements were repeated four times for each sample in two individual repetitions (at least).

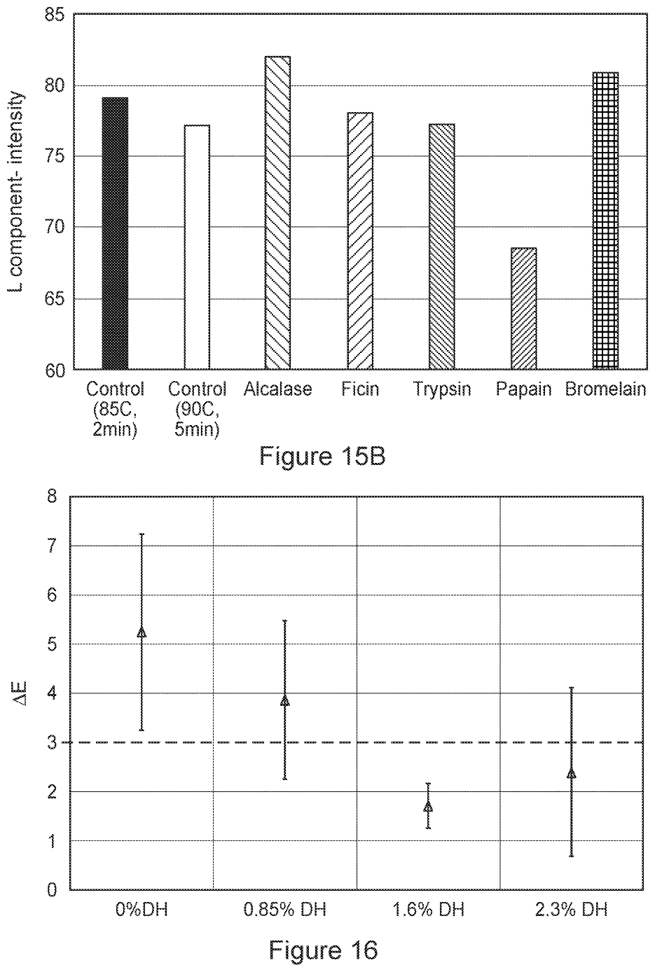

The results are presented in FIGS. 15A and 15B for Papain, Trypsin, Ficin, Bromelain and Alcalase; and in FIG. 16 (for Alcalase). Heat treatment (0% DH—inactivation at 90° C., 5 min) produces yogurt colour significantly different (ΔE≥3) as compared to control, i.e., lower L, a and b values. BLG Hydrolysis by Alcalase improves the colour, produces whiter yogurts, not significantly different from the control (the horizontal broken line is a semantic line symbolling the ‘naked eye’ threshold; beneath ΔE of ~3, the difference cannot be observed by a naked eye).

### Example 9. Foaming Capacity & Stability

The effect of BLG hydrolysis using Alcalase on foaming capacity of BLG was evaluated using as such: a BLG solution (4% w/w protein solution) hydrolyzed using alcalase to DH 0.85%, 1.6%, or 2.3%, DH 0% or control, 180 mL) was added into a glass beaker and the pH was adjust to pH=7.0. Next, 75 ml of the solution was added into a commercial whipping machine (Nespresso Aeroccino3 Milk Frother) and the foams height was measured. The solution was whipped for 30 sec to approximately 71-77° C. Subsequently, the height was measured again at four different points (2 high and 2 low points) and the foaming capacity (FC) was calculated according to equation Number 3:

$$Equation Number 3$$

$$Foaming capacity [ FC ] = \frac{{h}_{after whipping} - {h}_{before whipping}}{{h}_{before whipping}} * 100 \%$$

To measure the foam stability, the whipped solution was transferred into a glass beaker and the height was initially measured at four different points (2 high and 2 low points). The whipped solution was set at room temperature for 20 minutes and the height was measured again at four different points (2 high and 2 low points). The foaming stability was calculated according to equation Number 4:

$$Foaming stability [ FS ] = \frac{{h}_{t = 0} - {h}_{t = 20}}{{h}_{t = 0}} * 100 \% \qquad Equation Number 4$$

The foaming capacity and stability of all solutions were tested three times for each sample in two individual repetitions (at least).

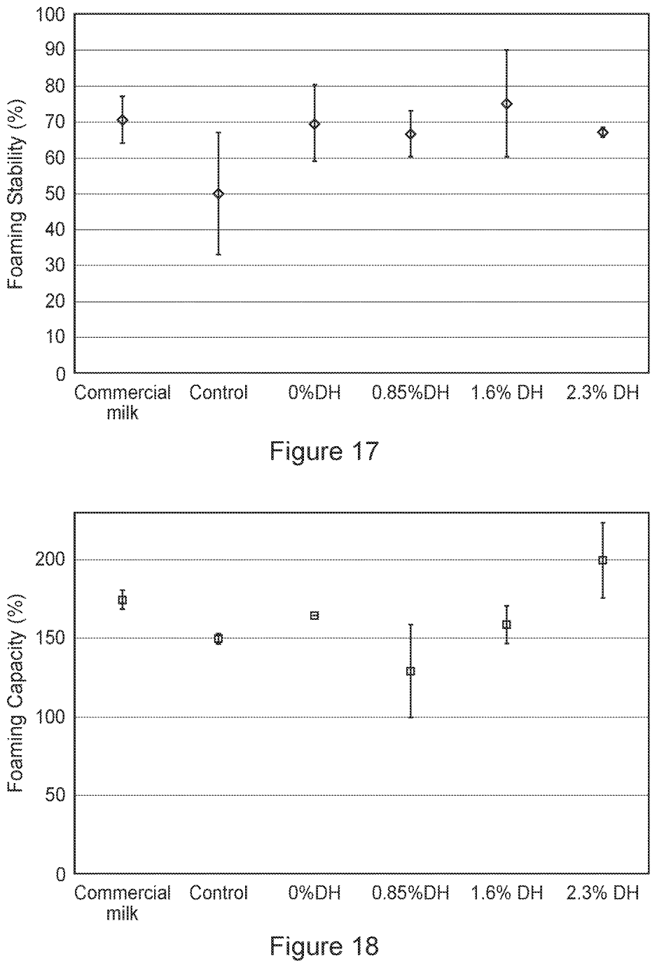

The results for foaming stability and foaming capacity are shown in FIGS. 17 and 18, respectively. In the figures Control-pasteurized BLG (85° C., 2 min) 4% BLG solution; 0% DH-BLG in conditions simulating heat inactivation (90° C., 5 min) 4% BLG solution.

Results show that BLG hydrolysis at the conditions tested had an insignificant difference in comparison to the controls. Thus, BLG maintains desirable foaming functionality after partial hydrolysis and is not negatively affected in terms of capacity and stability of the foam.

### Example 10. Yogurt Comprising BLG and BLG Hydrolysate

Methods described in Example 1 herein were applied on two types of products: Alcalase BLG-hydrolyzed solution (referred to as ‘solution’) and Alcalase BLG-hydrolyzed gel (referred to as ‘gel’) to better mimic commercial products such as yogurt.

To produce the gel, hydrolyzed BLG solutions (BLG hydrolysed to DH 0.85%, 1.6% and 2.3%) were mixed for 30 min at 40 C with dextrose, potato starch (Etenia 505, Avebe), inulin (Orafti®GR) and yeast extract (NuCel® 582 MG-Powder). Next, the samples were dispersed using an T 25 digital ULTRA-TURRAX for 30 sec at 5,000 rpm and pH was adjusted to pH=6.8. Finally, Vegan culture (VEGA™ Harmony, CHR Hansen) was added and the mixture was incubated at 38° C. overnight. The resulting product comprises: 4% BLG and BLG hydrolysate, collectively; 0.11% tri sodium citrate (TSC); 3.2% Dextrose; 1% Etenia 505; 3% Inulin GR; 0.0213% YE582; and 0.02% Harmony culture.

To evaluate the organoleptic properties of BLG-based gel products (yogurt type), a professional taste panel (n=10), evaluated the gels (control, 0%, 0.85%, 1.6% and 2.3% DH) in terms of yogurt flavors. The notes were summarized in Table 3.

TABLE 3

| | |
|---|---|
| Control | Not enough green, fresh, and cultured |
| 0% DH | Not enough green, fresh, and cultured, eggy off notes |
| 0.85% DH | Clean yogurt, acid, fresh, cultured, no cheesy off notes, |
| | smooth texture, no eggy off notes, white |
| 1.6% DH | Cultured, too much cheesy off notes in odor and flavor that |
| | mask yogurt flavors, smooth texture, no eggy off notes, |
| | white |
| 2.3% DH | Very strong cheesy off notes in odor and flavor that mask |
| | yogurt flavors, strong notes of cheese with mold, smooth |
| | texture, white |

Table 4. Summary of the effect of BLG hydrolysis on several properties of alternative dairy product presented in the above experiments.

TABLE 4

| | 0.85% DH | 1.6% DH | 2.3% DH |
|---|---|---|---|
| Foaming Capacity | — | — | — |
| Foaming Stability | — | — | — |
| Solubility (pH = 5.3) | ↑ | ↑ | ↑ |
| Buffering capacity | — | — | — |
| Colour | ↑ | ↑↑ | ↑↑ |
| Gel strength | ↓↓ | ↓↓ | ↓↓↓ |
| Viscosity | ↓↓ | ↓↓ | ↓↓↓ |
| % of intact BLG | ↓↓↓ | ↓↓↓ | ↓↓↓↓ |

Overall, results obtained for Alcalase controlled hydrolysis of BLG show that hydrolysis under a DH of 3% can significantly affect the texture of BLG-based products such as yogurts, forming softer and flowing gel-like textures. In terms of taste, at low DH % BLG hydrolysis by Alcalase can positively affect the taste. Higher DH % alter the taste and smell forming cheesy like notes which can be better suitable to products such as cream-cheese.

From the results of these experiments, it can be clearly seen that controlled hydrolysis of BLG can modify the organoleptic properties of BLG-based dairy products in terms of taste and texture.

### Example 11. Preparation of Dairy Product Comprising BLG Hydrolysate

### Yogurt Preparation.

Yogurt was prepared according to the following procedures: First, the phosphate salts (dipotassium phosphate and monopotassium phosphate; 0.3825% and 0.051% respectively) were hydrated in distilled water for 20 min at 25 Celsius degrees. Subsequently, the temperature was raised to 55 Celsius degrees and the following ingredients were added and mixed for 1 hr: Recombinant Hydrolyzed BLG solutions (BLG hydrolysed for 5, 10 or 15 min by Alcalase, Ficin, Trypsin, Chymotrypsin, Papain, Bromelain, final concentrations of BLG and BLG hydrolysate collectively in the final product was 3%), dextrose (3.2%), tri-sodium citrate (0.07%), starch (3.2%), inulin (1.5%) and threonine (0.12%). Then, fat (3.0%) was added to the solution and dispersed using a Turrax device (T 25 digital ULTRA-TURRAX, IKA, Germany). The emulsion was homogenized at 600 Bar at 65 Celsius degrees (GEA, Lab homogenizer Panda Plus 2000, Italy, two stages homogenization), pasteurized using a tubular heat exchanger (80 Celsius degrees, 5 min holding time; HTST/UHT Mini Pilot System, Armfield) and cooled down to 43 Celsius degrees. Finally, the starter cultures were added (0.01%) and the yogurt was incubated until reaching a pH of 4.0-4.3 (approximately 12-14 hr). The fermented curd was agitated and stored at 4 Celsius degrees until further examination. All concentrations refer to % w/w in the final product.

### Alternative Milk Preparation

Alternative milk was prepared according to the following procedures: first, the phosphate salts (sodium hexametaphosphate, dipotassium phosphate and monopotassium phosphate; 0.155%, 0.8% and 0.1% respectively) were hydrated in distilled water for 20 min at 25 Celsius degrees. Next, gellan gum was added, hydrated for 10 min, and activated by heating the solution to 90° Celsius for 30 sec holding time (via Thermomix TM5, Germany; mixing speed was set to 500 RPM at reverse knife mode). Immediately after, the solution was cooled to 50° Celsius and all other ingredients were added as following: Hydrolyzed BLG solutions (BLG hydrolysed for 5, 10 or 15 min by Alcalase, Ficin, Trypsin, Chymotrypsin, Papain, Bromelain, final concentrations of BLG and BLG hydrolysate collectively in the milk product were 3% and 8%, respectively), sucrose (2%), Arabic gum (0.18%), calcium carbonate (0.25%) and NaCl (0.05%). The ingredients were mixed at 50 Celsius degrees for 1 hr. Subsequently, the temperature was raised to 65 Celsius degrees and fat was introduced to the solution (3.5%). The solution was dispersed using Turrax (T 25 digital ULTRA-TURRAX, IKA, Germany) for 10 min at 1,000 RPM and then homogenized at 600 Bar at 65 Celsius degrees (GEA, Lab homogenizer Panda Plus 2000, Italy, two stages homogenization). Finally, the alternative milk was pasteurized using Thermomix (85 Celsius degrees, two sec holding time) and immediately stored at 4 Celsius degrees for further examination. All concentrations refer to % w/w in the final product.

Although the present invention has been described herein above by way of preferred embodiments thereof, it can be modified, without departing from the spirit and nature of the subject invention as defined in the appended claims.

1. A method for preparing an alternative dairy product with a modulated characteristic comprising a beta-lactoglobulin (BLG) protein, the method comprising the steps of:
(i) providing a composition comprising non-animal BLG proteins,
(ii) partially hydrolyzing the BLG proteins of the composition of step (i), thus obtaining a composition comprising a BLG protein and a BLG hydrolysate, and
(iii) formulating the composition obtained in step (ii) into an alternative dairy product, thus obtaining the alternative dairy product with the modulated characteristic,
wherein the characteristic is modulated in comparison to a corresponding characteristic in a corresponding dairy product which (a) comprises the same level of BLG proteins as in the composition of step (i), (b) is produced without the partial hydrolysis step in step (ii), and/or (c) is substantially devoid of a BLG hydrolysate.

2. The method of claim 1, wherein partially hydrolyzing the BLG proteins in step (ii) comprises contacting the BLG protein of the composition of step (i) with a protease enzyme.

3. The method of claim 1, wherein partially hydrolyzing the BLG proteins in step (ii) comprises hydrolyzing the BLG proteins to obtain a Degree of Hydrolysis (DH) of at least 0.5%.

4. The method of claim 1, wherein step (iii) comprises mixing the composition obtained in step (ii) with a lipid, a mineral, a salt, a sugar, lactic acid bacteria (LAB), or any combination thereof.

5. The method of claim 1, wherein the alternative dairy product obtained in step (iii) is selected from the group consisting of an alternative milk composition, an alternative yogurt composition, an alternative soft cheese composition, an alternative ice cream composition, and an alternative hard cheese composition.

6. The method of claim 1, wherein the modulated characteristic of the alternative dairy product obtained in step (iii) is selected from the group consisting of:
(i) Degree of Hydrolysis (DH) of the BLG protein,
(ii) Level of volatile sulfuric compounds (VSCs),
(iii) Level of texture firmness,
(iv) Level of texture consistency,
(v) Level of texture cohesiveness,
(vi) Level of texture work of cohesion,
(vii) Viscosity,
(viii) Level of overall solubility of BLG protein or BLG protein hydrolyzed fragments,
(ix) Level of the “L” value in the CIELAB color space,
(x) Level of the “a” value in the CIELAB color space,
(xi) Level of the “b” value in the CIELAB color space,
(xii) Gel strength,
(xiii) pH, and
(xiv) Any combination of (i) to (xiii).

7. The method of claim 1, wherein the BLG protein is a recombinant BLG protein.

8. The method of claim 1, wherein the alternative dairy product obtained in step (iii) is a non-animal dairy product.

9. An alternative dairy product with a modulated characteristic prepared by the method according to claim 1.

10. An alternative dairy product comprising a non-animal beta-lactoglobulin (BLG) protein and a BLG hydrolysate.

11. The dairy product of claim 10, wherein the dairy product comprises at least 0.1% w/w or from 0.1 to 10 wt % intact BLG protein.

12. The dairy product of claim 10, wherein the dairy product comprises from 0.5% w/w to 9.5% w/w of BLG hydrolysate.

13. The alternative dairy product of claim 10, wherein the alternative dairy product comprises from 1.75% w/w to 7.5% w/w of BLG hydrolysate and from 0.1% w/w to 5% w/w of intact BLG protein.

14. The alternative dairy product of claim 10, wherein the BLG hydrolysate has a DH of 1% to 9% or from 1.5% to 4%.

15. The alternative dairy product of claim 10, wherein the weight ratio between the BLG protein and the BLG protein hydrolysate is from about 1:3, respectively, to about 1:7, respectively.

16. The alternative dairy product of claim 10, further comprising a lipid, a mineral, a salt, a sugar, lactic acid bacteria (LAB), or any combination thereof.

17. The alternative dairy product of claim 10, wherein the BLG protein and the BLG hydrolysate are the only protein and protein hydrolysate, respectively, in the alternative dairy product.

18. The alternative dairy product of claim 10, wherein the alternative dairy product is a non-animal dairy product.


SEQUENCE LISTING (20 sequences)

SEQ ID NO: 1 - protein, 162 aa, synthetic construct
LIVTQTMKGLDIQKVAGTWYSLAMAASDISLLDAQSAPLRVYVEELKPTPEGDLEILLQKWENGECAQKKIIAEKTKIPAVFKIDALNENKVLVLDTDYKKYLLFCMENSAEPEQSLACQCLVRTPEVDDEALEKFDKALKALPMHIRLSFNPTQLEEQCHI

SEQ ID NO: 2 - protein, 162 aa, synthetic construct
LIVTQTMKGLDIQKVAGTWYSLAMAASDISLLDAQSAPLRVYVEELKPTPEGDLEILLQKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 3 - protein, 162 aa, synthetic construct
LIVTQTMKGLDIQKVAGTWYSLAMAASDISLLDAQSAPLRVYVEELKPTPEGDLEILLHKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 4 - protein, 162 aa, synthetic construct
LIVTQTMKGLDIQKVAGTWYSLAMAASDISLLDAQSAPLRVYVEQLKPTPEGDLEILLQKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 5 - protein, 162 aa, synthetic construct
LIVTQTMKGLDIQKVAGTWYSLAMAASNISLLDAQSAPLRVYVEELKPTPEGDLEILLQKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 6 - protein, 162 aa, synthetic construct
LIVTQTMKGLDIQKVAGTWYSLAMAASDISLLDAQSAPLRVYVEELKPTPEGDLEILLQKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEGQCHI

SEQ ID NO: 7 - protein, 162 aa, synthetic construct
LIVTQTMKGLDIQKVAGTWYSLAMAASDISLLDAQSAPLRVYVEELKPTSEGDLEILLQKWENDECAQKKIIAEKTKIPAVFKIDALNENKVLVLDTDYKKYLLFCMENSAEPEQSLVCQCLVRTPEVYYEALEKFDKALKALPMHIRLSFNPTQLEEQCHI

SEQ ID NO: 8 - protein, 162 aa, synthetic construct
LIVTQTMKGLDIQKVAGTWYSLAMAASDISLLDAQSAPLRVYVEELKPTPEGDLEILLQKWENDECAQKKIIAEKTKMPAVFKIDALNENKVLVLDTDYKKYLLFCMENSAEPEQSLVCQCLVRTPEVDDEALEKFDKALKALPMHIRLSFNPTQLEGQCHI

SEQ ID NO: 9 - protein, 162 aa, synthetic construct
LIVTQTMKGLDIQKVAGTWYSLAMAASDISLLDAQSAPLRVYVEELKPTPEGDLELLLQKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 10 - protein, 162 aa, synthetic construct
LIVTQTMKGLDIQKVAGTWYSLAMAASDISLLDAQSAPLRVYVEELKPTPEGDLEILLQKWENDECAQKKIIAEKTKIPAVFKIDALNENKVLVLDTDYKKYLLFCMGNSAEPEQSLVCQCLVRTPEVDDEALEKFDKALKALPMHIRLSFNPTQLEEQCHI

SEQ ID NO: 11 - protein, 162 aa, synthetic construct
LIVTQTMKGLDIQKVAGTWYSLAMAASDISLLDAQSAPLRVYVEELKPTPEGDLEILLHKWENGECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 12 - protein, 162 aa, synthetic construct; identical to SEQ ID NO: 3

SEQ ID NO: 13 - protein, 162 aa, synthetic construct; identical to SEQ ID NO: 8

SEQ ID NO: 14 - protein, 162 aa, synthetic construct; identical to SEQ ID NO: 9

SEQ ID NO: 15 - protein, 162 aa, synthetic construct
LIVTQTMKGLDIQKVAGTWYSLAMAASNISLLDAQSAPLRVYVEELKPTPEGDLEILLHKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 16 - protein, 162 aa, synthetic construct
LIVTQTMKGLDIQKVAGTWYSLAMAASDISLLDAQSAPLRVYVEELKPTPEGDLEILLHKWENDECAQKKIIAEKTKMPAVFKIDALNENKVLVLDTDYKKYLLFCMENSAEPEQSLVCQCLVRTPEVDDEALEKFDKALKALPMHIRLSFNPTQLEGQCHI

SEQ ID NO: 17 - protein, 162 aa, synthetic construct
LIVTQTMKGLDIQKVAGTWYSLAMAASDISLLDAQSAPLRVYVEELKPTPEGDLELLLHKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 18 - protein, 162 aa, synthetic construct
LIVTQTMKGLDIQKVAGTWYSLAMAASNISLLDAQSAPLRVYVEELKPTPEGDLEILLQKWENDECAQKKIIAEKTKMPAVFKIDALNENKVLVLDTDYKKYLLFCMENSAEPEQSLVCQCLVRTPEVDDEALEKFDKALKALPMHIRLSFNPTQLEGQCHI

SEQ ID NO: 19 - protein, 162 aa, synthetic construct
LIVTQTMKGLDIQKVAGTWYSLAMAASNISLLDAQSAPLRVYVEELKPTPEGDLELLLQKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI

SEQ ID NO: 20 - protein, 162 aa, synthetic construct
LIVTQTMKGLDIQKVAGTWYSLAMAASDISLLDAQSAPLRVYVEELKPTPEGDLELLLQKWENDECAQKKIIAEKTKMPAVFKIDALNENKVLVLDTDYKKYLLFCMENSAEPEQSLVCQCLVRTPEVDDEALEKFDKALKALPMHIRLSFNPTQLEGQCHI